(19) United States
(12) Patent Application Publication
(10) Pub. No.: US 2004/0236676 A1
(43) Pub. Date: Nov. 25, 2004

(54) Disaster risk assessment system, disaster risk assessment support method, disaster risk assessment service providing system, disaster risk assessment method, and disaster risk assessment service providing method

(75) Inventors: Nobuhisa Takezawa, Kanagawa (JP); Kazumi Miyagi, Kanagawa (JP); Yasuyuki Ito, Kanagawa (JP); Yuji Uenohara, Kanagawa (JP); Masatoshi Kawashima, Kanagawa (JP); Masayuki Takayama, Tokyo (JP); Hiroaki Okuda, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: KABUSHIKI KAISHA TOSHIBA, Tokyo (JP); TOSHIBA SOLUTIONS CORPORATION, Tokyo (JP)

(21) Appl. No.: 10/798,408

(22) Filed: Mar. 12, 2004

(30) Foreign Application Priority Data
Mar. 14, 2003 (JP) 2003-070627
Nov. 4, 2003 (JP) 2003-374941

(51) Int. Cl. G06F 17/60

(52) U.S. Cl. 705/38

(57) ABSTRACT

This disaster risk assessment system assesses a difference between a disaster-time direct loss amount in current equipment and disaster-time direct loss amount in equipment after taking measures and compares the difference with a disaster measures equipment cost for presenting decision making information on disaster measures. As assessment requirements, the system also takes a business value loss amount into consideration and presents an insurance premium that is required to cover an expected disaster-time loss amount by an insurance payment. In addition, the system assesses a direct loss amount, from which an amount compensated by a casualty insurance has been deducted, that is, a direct loss amount that a business owner must bear, with a casual insurance deductible or a maximum amount taken into consideration, and presents decision making information on disaster measures that allows the business owner to adequately assess a disaster risk associated with the occurrence of a disaster from an economic point of view, to make an economically feasible, appropriate disaster measures plan, and to estimate the cost of measures.

### CROSS REFERENCE TO RELATED APPLICATION

This application claims benefit of priority under 35 U.S.C. §119 to Japanese Patent Applications No. 2003-70627, filed on Mar. 14, 2003, and No. 2003-374941, filed on Nov. 4, 2003, the entire contents of which are incorporated by reference herein.

### BACKGROUND OF THE INVENTION

1. Field of the Invention

The present invention relates to a disaster risk assessment system, a disaster risk assessment support method, a disaster risk assessment service providing system, a disaster risk assessment method, and a disaster risk assessment service providing method for assessing direct losses, such as an equipment loss and an operating loss, that an owner, both individual and corporate, suffers from a disaster or an accident and business value losses that are caused by the suspension of business.

2. Description of the Related Art

The deterministic assessment method, one of conventional disaster risk assessment methods for risk management used by both individual and corporate owners, sets up a design basis disaster event and assesses if the loss (damage) of the equipment and property at a disaster event time is within the permissible range.

However, the loss (damage) assessed by the disaster risk assessment method based on the deterministic method described above is not a loss obtained by comprehensively assessing the safety and importance of the equipment and property methodically or quantitatively. For example, the method does not assess the loss (damage) based on the probability of occurrence or the degree of influence of a disaster event or a second disaster event. Therefore, a problem is that the method conservatively overestimates a loss (damage) caused by an event transition whose probability of occurrence or the degree of influence of a disaster event or a second disaster event is low or underestimates a loss (damage) caused by an event transition whose probability of occurrence or the degree of influence of a disaster event or a second disaster event is high. Another problem is that, because an elaborate, comprehensive assessment is not made for a change in the loss (damage) or a tradeoff in degree between the loss (damage) and the disaster measures when the disaster measures are taken, the method overestimates or underestimates the degree of necessary disaster measures.

To solve this problem, the probabilistic assessment method, one of conventional disaster risk assessment methods for risk management used by both individual and corporate owners, comprehensively assesses the safety and importance of the equipment and property methodically or quantitatively. Therefore, this method can assess a loss (damage) caused by a disaster based on the probability of occurrence or the degree of influence of a disaster event or a second disaster event and take appropriate disaster measures only from a safety viewpoint.

However, the disaster risk assessment based on the probabilistic method described above does not assess the total cost from an economic viewpoint. That is, this assessment method does not convert the safety or importance of the equipment and property to the cost related to a disaster risk, such as the direct loss amount including the equipment loss amount, in order to comprehensively assess the disaster risk methodically or quantitatively based on the probabilistic method. For example, the method does not assess the direct loss amount of the equipment loss amount based on the probability of occurrence or the degree of influence of a disaster event or a second disaster event. Therefore, a problem with the method is that the method conservatively overestimates a direct loss amount caused by an event transition whose probability of occurrence or degree of influence of a disaster event or a second disaster event is low or underestimates a direct loss amount caused by an event transition whose probability of occurrence or degree of influence of a disaster event or a second disaster event is high. Another problem is that, because an elaborate, comprehensive assessment is not made for a change in the direct loss amount or a tradeoff between the direct loss and the disaster measures when the disaster measures are taken, the method overestimates or underestimates the disaster measures equipment cost. That is, the problem is that the business owner can neither assess a disaster risk, related to the occurrence of a disaster, appropriately from an economic viewpoint nor can the business owner make an economically feasible, appropriate disaster measures plan and estimate the cost of measures.

Because the conventional disaster risk assessment does not assess the cost from an economic viewpoint, no assessment is made, of course, for the total cost considering the future business value affected by the suspension of business due to a disaster. However, in the service industries such as the financial industry and the newspaper industry, there is a risk that, once the business is suspended, the competitors will win the customers and a part of the market share will be lost permanently. Therefore, when making a disaster risk assessment, it is important to assess, from an economic viewpoint, the total cost considering the future business value affected by the suspension of business due to a disaster.

Because the conventional disaster risk assessment does not assess the total cost from an economic viewpoint, the premium and the insurance amount of a casualty insurance against a disaster are not selected considering the balance between a direct loss amount and a disaster measures equipment cost. Therefore, there are some cases in which the relation between the insurance amount and the premium of a casualty insurance that is taken out is not appropriate from an economic viewpoint. The problem is that the business owner cannot make an economically feasible, appropriate disaster measures plan nor can the business owner estimate the correct value of the cost, sometimes resulting in an overestimated or underestimated value of the cost.

In addition, when assessing the direct loss amount such as the equipment loss amount or operating loss amount, the disaster risk assessment described above does not assess the direct loss amount from which, based on the conditions such as the deductible or maximum insurance amount, the amount compensated by the casualty insurance has been deducted, that is, the direct loss amount the business owner must bear when a disaster occurs. Therefore, the problem is that the business owner cannot make an economically feasible, appropriate disaster measures plan nor can the business owner estimate the correct value of the cost, sometimes resulting in an overestimated or underestimated value of the cost.

The conventional disaster risk assessment described above involves an uncertainty in the operating revenue and the cash flow at a time when assessing the operating loss amount or the business value loss amount caused by a potential disaster. This in turn involves an uncertainty in the operating loss amount and the business value loss amount, interfering with the decision making of disaster measures. In particular, if the effect of disaster measures, which is generated by subtracting the sum of the expected value of the operating loss amount and the business value loss amount assessed assuming that disaster measures will be taken and all costs necessary for taking the disaster measures from the expected value of the operating loss amount and the business value loss amount assessed in the current business environment assuming that no disaster measures will be taken is negative, the resulting decision making is that there is no need for disaster measures. However, this judgment is sometimes dangerous because taking disaster measures will potentially become worthwhile considering the possibility that the operating revenue and cash flow will increase in future. In addition, when there are multiple businesses units in one business place owned by an individual or corporate business owner, the degree of influence of disaster occurrence differs from business unit to business unit and therefore separate assessment is needed.

That is, in the conventional disaster risk assessment described above, the assessment of disaster contingency planning and the cost of measures, which are used for deciding whether to take disaster measures, are insufficient and therefore satisfactory disaster measures cannot be decided.

### SUMMARY OF THE INVENTION

To solve the problems of the conventional technologies, it is an object of the present invention to provide a disaster risk assessment technology that allows a business owner to adequately assess a disaster risk associated with the occurrence of a disaster from an economic point of view and to make an economically feasible, appropriate disaster measures plan and estimate the cost of the measures.

In particular, it is another object of the present invention to provide a disaster risk assessment technology that allows a business owner to adequately assess a disaster risk associated with the occurrence of a disaster from an economic point of view and to make an economically feasible, appropriate disaster measures plan and estimate the cost of the measures, wherein, when assessing the direct loss amount such as the equipment loss amount or the operating loss amount, the total cost, including a business value loss amount caused by the suspension of business due to a disaster, is assessed by assessing the direct loss amount from which, based on the conditions such as the deductible or maximum insurance amount, the amount compensated by the casualty insurance has been deducted.

It is still another object of the present invention to provide a disaster risk assessment technology that assesses the expected value of an operating loss amount or a business value loss amount at a disaster occurrence time considering an uncertainty in the future operating revenue or cash flow and that supports the decision making deciding whether to execute disaster measures.

To achieve the above objects, there is provided a disaster risk assessment system comprising a function that compares a function-losing event occurrence frequency and a direct loss amount such as a facility loss amount in current equipment with a function-losing event occurrence frequency and a direct loss amount such as a facility loss amount after taking equipment measures for presenting decision-making information on equipment measures, based on input data on an event tree branch item sequence, an initial event occurrence frequency, information on a response to a target facility when an event occurs in current equipment and multiple pieces of counter-disaster equipment of an event tree target facility, a damage probability at an event occurrence time, a mission time, a conditional failure probability, and a cost of current equipment and counter-disaster equipment of an event target facility.

In a preferred embodiment of the present invention, the disaster risk assessment system further comprises a function that assesses a difference between a sum of the direct loss amount and a business value loss amount at disaster time in the current equipment and a sum of the direct loss amount and a business value loss amount at disaster time in the counter-disaster equipment after taking disaster measures and compares the difference with a disaster measures equipment cost for presenting decision making information on disaster measures.

In a preferred embodiment of the present invention, the disaster risk assessment system further comprises a function that compares a sum of a casualty insurance premium against a disaster and a disaster measures equipment cost in the current equipment with a sum of a casualty insurance premium against a disaster and a disaster measures equipment cost in the counter-disaster equipment after disaster measures are taken for presenting decision making information on disaster measures.

In a preferred embodiment of the present invention, the disaster risk assessment system further comprises a function that compares a total cost, which is generated by subtracting an insurance amount at disaster time from a sum of the direct loss amount at disaster time, disaster measures equipment cost, disaster measures management cost, suspension-causing business value loss amount at disaster time, and casualty insurance premium against a disaster in the current equipment, with a total cost, which is generated by subtracting an insurance amount at disaster time from a sum of the direct loss amount at disaster time, disaster measures equipment cost, disaster measures management cost, suspension-causing business value loss amount at disaster time, and casualty insurance premium against a disaster in the counter-disaster equipment after disaster measures are taken, for presenting decision making information on disaster measures

In a preferred embodiment of the present invention, the business value loss amount is a business value loss amount assessed considering a time-based decrease in a market share due to a suspension and a restart from the suspension

In a preferred embodiment of the present invention, the business value loss amount is assessed from a difference between a current value of a total future profit or a total cash flow obtained from the business when a suspension occurs and a current value of a total future profit or a total cash flow expected when no suspension occurs.

In a preferred embodiment of the present invention, the disaster risk assessment system further comprises a function that assesses a business value loss amount expected value of a disaster based on occurrence probabilities of a plurality of loss events assessed by an event tree of loss events created for the disaster and on a suspension-causing business value loss amount generated corresponding to the event tree and the plurality of loss events.

In a preferred embodiment of the present invention, the plurality of loss events are rearranged in descending order of occurrence probabilities thereof and the business value loss amount expected value of a disaster is assessed expression (1) using the suspension-causing business value loss amount generated corresponding to the plurality of loss events,

$$V = {\sum }_{k = 0}^{n} {p}_{k} Δ {v}_{k} \qquad ( 1 )$$

where,

V: Expected value of suspension-causing business value loss amount

n: No. of assumed loss events

pₖ: Occurrence probability of k-th loss event (pₖ≦Pₖ₋₁, K=1, 2, . . . , n)

Δv₀=v₀

Δv₀=vₖ−vₖ₋₁ (vₓ≧vₖ₋₁, k=1, 2, . . . , n)

Δvₖ=0 (vₖ<vₖ₋₁, k=1, 2, . . . , n)

vₖ: Business value loss amount for k-th loss event

To achieve the above objects, there is provided a disaster risk assessment system comprising: a data entry unit that receives data on an assumed disaster event, a relation between an assumed disaster occurrence frequency and a disaster scale, event tree information, equipment data on a target facility that is an event tree branch item, response analysis information on equipment of a target facility for a disaster event, degree-of-damage information on equipment of a target facility, an equipment reconstruction cost of a target facility, a number of days for recovery, an operating loss amount, deductible or maximum amount or premium data on casualty insurance of a target facility, alternate equipment data on a target facility that is an event tree branch item, response analysis information on alternate equipment of a target facility for a disaster event, degree-of-damage information on alternate equipment of a target facility, an alternate equipment reconstruction cost of a target facility, a number of days for recovery, an operating loss amount, and a deductible or maximum amount or premium of casualty insurance of a target facility when alternate equipment is installed; a hazard curve estimation unit that gives a disaster hazard curve of a target district; an occurrence frequency assessment unit that assesses an occurrence frequency of a disaster event based on the disaster hazard curve; a target part response assessment unit that assesses a response acceleration of a target part using an acceleration amplification coefficient for each target part of a target building; a target facility failure rate estimation unit that calculates a target facility failure rate of an event tree branch event item based on an assessment result of the target part response assessment unit; a disaster loss amount assessment unit that assesses a damage probability, a direct loss amount, and a suspension-causing business value loss amount of a corresponding damage mode by classifying a damage mode after the occurrence of a disaster based on event tree information; a direct loss amount expected value calculation unit that calculates a direct loss amount expected value by calculating a total of products of the damage probability and the direct loss amount of the damage modes; a business value loss amount expected value estimation unit that calculates a business value loss amount expected value by calculating a total of products of the damage probability and the business value loss amount of the damage modes; and an information presentation unit that presents decision making information on disaster measures by comparing a function-losing event occurrence frequency, a direct loss amount expected value, a disaster measures cost, a business value loss amount expected value, and a casualty insurance premium in current equipment with a function-losing event occurrence frequency, a direct loss amount expected value, a disaster measures cost, a business value loss amount expected value, and a casualty insurance premium in counter-disaster equipment after disaster measures are taken, wherein the disaster loss amount assessment unit uses a direct loss amount, from which a casualty insurance compensation determined by a casualty insurance deductible and maximum amount is deducted, as the direct loss amount, and wherein the direct loss amount expected value calculation unit uses a direct loss amount expected value, from which a casualty insurance compensation determined by a casualty insurance deductible and maximum amount is deducted, as the direct loss amount expected value.

In a preferred embodiment of the present invention, the direct loss amount includes an operating loss amount, the operating loss amount is an operating loss amount from which a business casualty insurance compensation determined by a business casualty insurance deductible and maximum amount is deducted, and an operating loss amount expected value is an operating loss amount expected value from which the business casualty insurance compensation determined by the business casualty insurance deductible and maximum amount is deducted.

In a preferred embodiment of the present invention, the direct loss amount includes an equipment loss amount, the equipment loss amount is an equipment loss amount from which an equipment casualty insurance compensation determined by an equipment casualty insurance deductible and maximum amount is deducted, and an equipment loss amount expected value is an equipment loss amount expected value from which the equipment casualty insurance compensation determined by the equipment casualty insurance deductible and maximum amount is deducted.

In a preferred embodiment of the present invention, the casualty insurance premium determined by the casualty insurance deductible and maximum amount is assessed.

In a preferred embodiment of the present invention, the business value loss amount is a business value loss amount including a profit and loss of a time-based decrease in a market share due to a suspension and a restart of business.

In a preferred embodiment of the present invention, the business value loss amount is assessed from a difference between a current value of a total future profit or a total cash flow obtained from the business when a suspension occurs and a current value of a total future profit or a total cash flow expected when no suspension occurs.

In a preferred embodiment of the present invention, a business value loss amount expected value of a disaster is assessed based on occurrence probabilities of a plurality of loss events obtained from event tree information on loss events created for the disaster and on a suspension-causing business value loss amount generated corresponding to the event tree information and the plurality of loss events.

In a preferred embodiment of the present invention, the plurality of loss events are rearranged in descending order of occurrence probabilities, a difference between the business value loss amount of a particular loss event and the business value loss amount of a loss event in a level immediately preceding the particular loss event is compared with 0, and a total sum of amounts, each generated by multiplying the difference greater than 0 by the occurrence probability of the particular loss event, and an amount generated by multiplying the business value loss amount of a highest-occurrence-probability loss event by the occurrence probability thereof is established as the business value loss amount expected value of the disaster. The operation described above can be represented by expression (2).

$$V = {\sum }_{k = 0}^{n} {p}_{k} Δ {v}_{k} \qquad ( 2 )$$

where,

V: Expected value of suspension-causing business value loss amount

n: No. of assumed loss events

pₖ: Occurrence probability of k-th loss event (pₖ≦Pₖ₋₁, K=1, 2, - - - , n)

Δv₀=v₀

Δv₀=vₖ−vₖ₋₁ (vₖ≧vₖ₋₁, k=1, 2, . . . , n)

Δvₖ=0 (vₖ<vₖ₋₁, k=1, 2, . . . , n)

vₖ: Business value loss amount for k-th loss event

To achieve the above objects, there is provided a disaster risk assessment support method causing a computer to assess a difference between a sum of a direct loss amount and a business value loss amount at disaster time in current equipment and a sum of a direct loss amount and a business value loss amount at disaster time in counter-disaster equipment after taking disaster measures and to compare the difference with a disaster measures equipment cost for presenting decision making information on disaster measures.

In a preferred embodiment of the present invention, the method further causes the computer to compare a sum of a casualty insurance premium against a disaster and a disaster measures equipment cost in the current equipment with a sum of a casualty insurance premium against a disaster and a disaster measures equipment cost in the counter-disaster equipment for presenting decision making information on disaster measures.

In a preferred embodiment of the present invention, the method further causes the computer to compare a total cost, which is generated by subtracting an insurance amount at disaster time from a sum of the direct loss amount at disaster time, disaster measures equipment cost, disaster measures management cost, suspension-causing business value loss amount at disaster time, and a casualty insurance premium against a disaster in the current equipment, with a total cost, which is generated by subtracting an insurance amount at disaster time from a sum of the direct loss amount at disaster time, disaster measures equipment cost, disaster measures management cost, suspension-causing business value loss amount at disaster time, and a casualty insurance premium against a disaster in the counter-disaster equipment after disaster measures are taken, for presenting decision making information on disaster measures.

To achieve the above objects, there is provided a disaster risk assessment support method causing a computer to perform the steps of: receiving data on an assumed disaster event, a relation between an assumed disaster occurrence frequency and a disaster scale, event tree information, equipment data on a target facility that is an event tree branch item, response analysis information on equipment of a target facility for a disaster event, degree-of-damage information on equipment of a target facility, an equipment reconstruction cost of a target facility, a number of days for recovery, an operating loss amount, deductible or maximum amount or premium data on casualty insurance of a target facility, alternate equipment data on a target facility that is an event tree branch item, response analysis information on alternate equipment of a target facility for a disaster event, degree-of-damage information on alternate equipment of a target facility, an alternate equipment reconstruction cost of a target facility, a number of days for recovery, an operating loss amount, and a deductible or maximum amount or premium of casualty insurance of a target facility when alternate equipment is installed; giving a disaster hazard curve of a target district; assessing an occurrence frequency of a disaster event based on the disaster hazard curve; assessing a response acceleration of a target part using an acceleration amplification coefficient for each target part of a target building; calculating a target facility failure rate of an event tree branch event item based on an assessment result of the step of assessing a response acceleration of a target part; assessing a damage probability, a direct loss amount, and a suspension-causing business value loss amount of a corresponding damage mode by classifying a damage mode after the occurrence of a disaster based on event tree information; calculating a direct loss amount expected value by calculating a total of products of the damage probability and the direct loss amount of the damage modes; calculating a business value loss amount expected value by calculating a total of products of the damage probability and the business value loss amount of the damage modes; and presenting decision making information on disaster measures by comparing a function-losing event occurrence frequency, a direct loss amount expected value, a disaster measures cost, a business value loss amount expected value, and a casualty insurance premium in current equipment with a function-losing event occurrence frequency, a direct loss amount expected value, a disaster measures cost, a business value loss amount expected value, and a casualty insurance premium in counter-disaster equipment after disaster measures are taken, wherein the step of assessing a disaster loss amount uses a direct loss amount, from which a casualty insurance compensation determined by a casualty insurance deductible and maximum amount is deducted, as the direct loss amount, and wherein the step of calculating a direct loss amount expected value uses a direct loss amount expected value, from which a casualty insurance compensation determined by a casualty insurance deductible and maximum amount is deducted, as the direct loss amount expected value.

In a preferred embodiment of the present invention, the direct loss amount includes an operating loss amount, the operating loss amount is an operating loss amount from which a business casualty insurance compensation determined by a business casualty insurance deductible and maximum amount is deducted, and an operating loss amount expected value is an operating loss amount expected value from which the business casualty insurance compensation determined by the business casualty insurance deductible and maximum amount is deducted.

In a preferred embodiment of the present invention, the direct loss amount includes an equipment loss amount, the equipment loss amount is an equipment loss amount from which an equipment casualty insurance compensation determined by an equipment casualty insurance deductible and maximum amount is deducted, and an equipment loss amount expected value is an equipment loss amount expected value from which the equipment casualty insurance compensation determined by the equipment casualty insurance deductible and maximum amount is deducted.

In a preferred embodiment of the present invention, the method causes the computer to assess the casualty insurance premium determined by the casualty insurance deductible and maximum amount.

In a preferred embodiment of the present invention, the business value loss amount is a business value loss amount including a profit and loss of a time-based decrease in a market share due to a suspension and a restart of business.

In a preferred embodiment of the present invention, the method causes the computer to assess the business value loss amount from a difference between a current value of a total future profit or a total cash flow obtained from the business when a suspension occurs and a current value of a total future profit or a total cash flow expected when no suspension occurs.

In a preferred embodiment of the present invention, the method causes the computer to assess a business value loss amount expected value of a disaster based on occurrence probabilities of a plurality of loss events obtained from event tree information on loss events created for the disaster and on a suspension-causing business value loss amount generated corresponding to the event tree information and the plurality of loss events.

In a preferred embodiment of the present invention, the method causes the computer to rearrange the plurality of loss events in descending order of occurrence probabilities; to compare a difference between the business value loss amount of a particular loss event and the business value loss amount of a loss event in a level immediately preceding the particular loss event with 0; and to establish a total sum of amounts, each generated by multiplying the difference greater than 0 by the occurrence probability of the particular loss event, and an amount, generated by multiplying the business value loss amount of a highest-occurrence-probability loss event by the occurrence probability thereof, as the business value loss amount expected value of the disaster. The operation described above can be represented by expression (3).

$$V = {\sum }_{k = 0}^{n} {p}_{k} Δ {v}_{k} \qquad ( 3 )$$

where,

V: Expected value of suspension-causing business value loss amount

n: No. of assumed loss events

pₖ: Occurrence probability of k-th loss event (pₖ≦Pₖ₋₁, K=1, 2, . . . , n)

Δv₀=v₀

Δvₖ=vₖ−vₖ₋₁ (vₖ≧vₖ₋₁, k−1, 2, . . . , n)

Δvₖ=0 (vₖ<vₖ₋₁, k=1, 2, . . . , n)

vₖ: Business value loss amount for k-th loss event

To achieve the above objects, there is provided a disaster risk assessment system comprising: a data entry unit that receives data on an assumed disaster event, a relation between an assumed disaster occurrence frequency and a disaster scale, event tree information, equipment data on a target facility that is an event tree branch item, response analysis information on equipment of a target facility for a disaster event, degree-of-damage information on equipment of a target facility, an equipment reconstruction cost of a target facility, a number of days for recovery, an operating loss amount, deductible or maximum amount or premium data on casualty insurance of a target facility, alternate equipment data on a target facility that is an event tree branch item, response analysis information on alternate equipment of a target facility for a disaster event, degree-of-damage information on alternate equipment of a target facility, an alternate equipment reconstruction cost of a target facility, a number of days for recovery, an operating loss amount, and a deductible or maximum amount or premium of casualty insurance of a target facility when alternate equipment is installed; a hazard curve estimation unit that gives a disaster hazard curve of a target district; an occurrence frequency assessment unit that assesses an occurrence frequency of a disaster event based on the disaster hazard curve; a target part response assessment unit that assesses a response acceleration of a target part using an acceleration amplification coefficient for each target part of a target building; a target facility failure rate estimation unit that calculates a target facility failure rate of an event tree branch event item based on an assessment result of the target part response assessment unit; a disaster loss amount assessment unit that assesses a damage probability, a direct loss amount, and a suspension-causing business value loss amount of a corresponding damage mode by classifying a damage mode after the occurrence of a disaster based on event tree information; a direct loss amount expected value calculation unit that calculates a direct loss amount expected value by calculating a total of products of the damage probability and the direct loss amount of the damage modes; a business value loss amount expected value estimation unit that calculates a business value loss amount expected value by calculating a total of products of the damage probability and the business value loss amount of the damage modes; and an information presentation unit that presents decision making information on disaster measures by comparing a function-losing event occurrence frequency, a direct loss amount expected value, a disaster measures cost, a business value loss amount expected value, and a casualty insurance premium in current equipment with a function-losing event occurrence frequency, a direct loss amount expected value, a disaster measures cost, a business value loss amount expected value, and a casualty insurance premium in counter-disaster equipment after disaster measures are taken, wherein the business value loss amount expected value estimation unit calculates the business value loss amount expected value based on a probability distribution of a business profit or a cash flow.

In a preferred embodiment of the present invention, the business value loss amount expected value estimation unit assesses a disaster measures effect based on the probability distribution of a business profit or a cash flow and causes the information presentation unit to present the disaster measures effect, and the disaster measures effect is a value generated by subtracting a sum of a business value loss amount expected value assessed assuming that disaster measures will be taken and a total cost for taking disaster measures from a business value loss amount expected value assessed in a current business environment in which no disaster measures is taken.

In a preferred embodiment of the present invention, the business value loss amount expected value estimation unit assesses a real option value and causes the information presentation unit to present the real option value, wherein a property value is a value generated by subtracting a business value loss amount expected value assessed assuming that disaster measures will be taken from a business value loss amount expected value assessed in a current business environment in which no disaster measures is taken, a volatility is a standard deviation of a variation in a business profit or a cash flow per unit time, an exercise price is a total cost for taking disaster measures, and an expiration is a period to a time when disaster measures are taken.

To achieve the above objects, there is provided disaster risk assessment system comprising: a data entry unit that receives data on an assumed disaster event, a relation between an assumed disaster occurrence frequency and a disaster scale, event tree information, equipment data on a target facility that is an event tree branch item, response analysis information on equipment of a target facility for a disaster event, degree-of-damage information on equipment of a target facility, an equipment reconstruction cost of a target facility, a number of days for recovery, an operating loss amount, deductible or maximum amount or premium data on casualty insurance of a target facility, alternate equipment data on a target facility that is an event tree branch item, response analysis information on alternate equipment of a target facility for a disaster event, degree-of-damage information on alternate equipment of a target facility, an alternate equipment reconstruction cost of a target facility, a number of days for recovery, an operating loss amount, and a deductible or maximum amount or premium of casualty insurance of a target facility when alternate equipment is installed; a hazard curve estimation unit that gives a disaster hazard curve of a target district; an occurrence frequency assessment unit that assesses an occurrence frequency of a disaster event based on the disaster hazard curve; a target part response assessment unit that assesses a response acceleration of a target part using an acceleration amplification coefficient for each target part of a target building; a target facility failure rate estimation unit that calculates a target facility failure rate of an event tree branch event item based on an assessment result of the target part response assessment unit; a disaster loss amount assessment unit that assesses a damage probability, a direct loss amount, and a suspension-causing business value loss amount of a corresponding damage mode by classifying a damage mode after the occurrence of a disaster based on event tree information; a direct loss amount expected value calculation unit that calculates a direct loss amount expected value by calculating a total of products of the damage probability and the direct loss amount of the damage modes; a business value loss amount expected value estimation unit that calculates a business value loss amount expected value by calculating a total of products of the damage probability and the business value loss amount of the damage modes; and an information presentation unit that presents decision making information on disaster measures by comparing a function-losing event occurrence frequency, a direct loss amount expected value, a disaster measures cost, a business value loss amount expected value, and a casualty insurance premium in current equipment with a function-losing event occurrence frequency, a direct loss amount expected value, a disaster measures cost, a business value loss amount expected value, and a casualty insurance premium in counter-disaster equipment after disaster measures are taken, wherein the business value loss amount expected value estimation unit assesses the operating loss amount expected value based on a probability distribution of a business profit or a cash flow.

In a preferred embodiment of the present invention, a disaster measures effect is assessed and presented based on the probability distribution of a future business profit or a cash flow, wherein the disaster measure effect is a value generated by subtracting a sum of an operating loss amount expected value assessed assuming that disaster measures will be taken and a total cost for taking disaster measures from an operating loss amount expected value assessed in a current business environment in which no disaster measures is taken.

In a preferred embodiment of the present invention, a real option value is assessed, wherein a property value is a value generated by subtracting an operating loss amount expected value assessed assuming that disaster measures will be taken from an operating loss amount expected value assessed in a current business environment in which no disaster measures is taken, a volatility is a standard deviation of a variation in a business profit or a cash flow per unit time, an exercise price is a total cost for taking disaster measures, and an expiration is a period to a time when disaster measures are taken.

In a preferred embodiment of the present invention, the disaster risk assessment system further comprises a function that assesses the operating loss amount and the business value loss amount of each business unit within a business establishment for which disaster risk assessment is made and presents the assessment value of each business unit and a total of all business units.

To achieve the above objects, there is provided a disaster risk assessment service providing system comprising: input means for receiving a user-desired calculation condition, sent from a user terminal via a network, for input to the system; the above-described disaster risk assessment system that calculates at least one disaster risk assessment value based on the user-desired calculation condition received by the input means; and output means for sending a disaster risk assessment value, calculated by the disaster risk assessment system, to the user terminal.

To achieve the above objects, there is provided a disaster risk assessment method comprising the steps of: receiving data on an assumed disaster event, a relation between an assumed disaster occurrence frequency and a disaster scale, event tree information, equipment data on a target facility that is an event tree branch item, response analysis information on equipment of a target facility for a disaster event, degree-of-damage information on equipment of a target facility, an equipment reconstruction cost of a target facility, a number of days for recovery, an operating loss amount, deductible or maximum amount or premium data on casualty insurance of a target facility, alternate equipment data on a target facility that is an event tree branch item, response analysis information on alternate equipment of a target facility for a disaster event, degree-of-damage information on alternate equipment of a target facility, an alternate equipment reconstruction cost of a target facility, a number of days for recovery, an operating loss amount, and a deductible or maximum amount or premium of casualty insurance of a target facility when alternate equipment is installed; obtaining a disaster hazard curve of a target district; assessing an occurrence frequency of a disaster event based on the disaster hazard curve; assessing a response acceleration of a target part using an acceleration amplification coefficient for each target part of a target building; calculating a target facility failure rate of an event tree branch event item based on an assessment result of the step of assessing a response acceleration of a target part; assessing a damage probability, a direct loss amount, and a suspension-causing business value loss amount of a corresponding damage mode by classifying a damage mode after the occurrence of a disaster based on event tree information; calculating a direct loss amount expected value by calculating a total of products of the damage probability and the direct loss amount of the damage modes; calculating a business value loss amount expected value by calculating a total of products of the damage probability and the business value loss amount of the damage modes; and presenting decision making information on disaster measures by comparing a function-losing event occurrence frequency, a direct loss amount expected value, a disaster measures cost, a business value loss amount expected value, and a casualty insurance premium in current equipment with a function-losing event occurrence frequency, a direct loss amount expected value, a disaster measures cost, a business value loss amount expected value, and a casualty insurance premium in counter-disaster equipment after disaster measures are taken, wherein a disaster measures effect is assessed based on the probability distribution of a business profit or a cash flow, wherein the disaster measure effect is a value generated by subtracting a sum of a business value loss amount or an operating loss amount expected value assessed assuming that disaster measures will be taken and a total cost for taking disaster measures from a business value loss amount or an operating loss amount expected value assessed in a current business environment in which no disaster measures is taken.

To achieve the above objects, there is provided a disaster risk assessment service providing method comprising the steps of: receiving a user-desired calculation condition, sent from a user terminal via a network, for input; calculating at least one disaster risk assessment value, using the above-described disaster risk assessment system, based on the user-desired calculation condition that is received; and sending the calculated disaster risk assessment value to the user terminal.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a block diagram showing the functional configuration of a disaster risk assessment system in a first embodiment of the present invention;

FIGS. 2A-2C are diagrams showing assumed disaster/district information entry, equipment information entry (1), and equipment information entry (2) that are information input to the disaster risk assessment system in the embodiment;

FIGS. 3A-3C are diagrams showing alternate equipment information entry (1), alternate equipment information entry (2), and financial management information entry that are information input to the disaster risk assessment system in the embodiment;

FIG. 4 is a block diagram showing the functional configuration of a data processor of the disaster risk assessment system in the embodiment;

FIG. 5 is a diagram showing an example of an earthquake hazard curve estimated by a disaster (earthquake) hazard curve estimation unit 10 of the disaster risk assessment system in the embodiment;

FIGS. 6A and 6B are charts showing an example of the outline of an assumed building, and the installed equipment configuration of the building and estimated acceleration amplification coefficients used during the processing of an acceleration amplification coefficient (target part response acceleration) estimation unit in the disaster risk assessment system in the embodiment;

FIG. 7 is a chart showing an example of parameters of the fragility (degree of damage) curve of a building and equipment/apparatus used when a target facility failure rate (fragility) estimation unit of the disaster risk assessment system in the embodiment estimates the target facility failure rate (fragility) of an event tree branch event item;

FIG. 8 is a graph showing an example of the fragility (degree of damage) curve of a building and equipment/apparatus used when the target facility failure rate (fragility) estimation unit of the disaster risk assessment system in the embodiment estimates the target facility failure rate (fragility) of an event tree branch event item;

FIG. 9 is a chart showing an example of data on equipment reconstruction costs, number of suspension days (number of days for recovery), and operating loss amount that are used during the processing of a direct loss amount estimation unit of the disaster risk assessment system in the embodiment as equipment cost information or alternate equipment cost information;

FIGS. 10A and 10B are diagrams showing an example of an event tree for an operating loss created by an event tree creation unit of the disaster risk assessment system in the embodiment;

FIG. 11 is a graph showing a relation, before and after taking measures, between a loss amount and the occurrence probability of a function-losing event causing the loss amount when a disaster presented by the disaster risk assessment system in the embodiment occurs;

FIG. 12 is a graph showing a relation, before and after taking measures, among the function-losing event occurrence frequency, equipment loss amount relative value, and disaster measures equipment relative cost when a disaster presented by the disaster risk assessment system in the embodiment occurs;

FIG. 13 is a diagram showing an example of a fault tree used when the target facility failure rate (fragility) estimation unit in the disaster risk assessment system in the embodiment estimates the target facility failure rate (fragility) of an event tree branch event item;

FIGS. 14A-14D are diagrams showing an example of an event tree of an equipment loss that is created by the event tree creation unit of the disaster risk assessment system in the embodiment;

FIG. 15 is a diagram showing an estimation model of a suspension-causing business value loss amount, caused by the occurrence of a disaster, used by the disaster risk assessment system in the embodiment;

FIG. 16 is a block diagram showing the functional configuration of a suspension-causing business value loss amount assessment unit of the disaster risk assessment system in the embodiment;

FIG. 17 is a graph showing a relation, before and after taking measures, between a direct loss amount expected value and the occurrence probability of a function-losing event causing the loss amount when a disaster presented by the disaster risk assessment system in the embodiment occurs;

FIG. 18 is a chart showing a relation, before and after taking measures, among the cost of disaster measures, yearly premium of casualty insurance, yearly direct loss amount expected value, and business value loss amount expected value when a disaster presented by the disaster risk assessment system in the embodiment occurs;

FIG. 19 is a block diagram showing the functional configuration of a data processor in a disaster risk assessment system in a fourth embodiment of the present invention;

FIG. 20 is a block diagram showing the functional configuration of a casualty insurance premium assessment unit of the disaster risk assessment system in the embodiment;

FIG. 21 is a chart showing a relation, before and after taking measures, among the cost of disaster measures, yearly premium of casualty insurance, yearly direct loss amount expected value, and business value loss amount expected value when a disaster presented by the disaster risk assessment system in the embodiment occurs;

FIG. 22 is a diagram showing the probability density distribution and cumulative probability distribution of a business profit, operating loss amount, and business value loss amount in the disaster risk assessment system in the embodiment;

FIG. 23 is a diagram showing the probability density distribution and the cumulative probability distribution of a disaster measures effect for a business profit, operating loss amount, and business value loss amount used in the embodiment;

FIG. 24 is a diagram showing an example of a real option value assessment result for supporting the decision making to decide whether to take disaster measures used in the embodiment; and

FIG. 25 is a block diagram showing a disaster risk assessment system in an eighth embodiment of the present invention.

### DESCRIPTION OF THE PREFERRED EMBODIMENTS

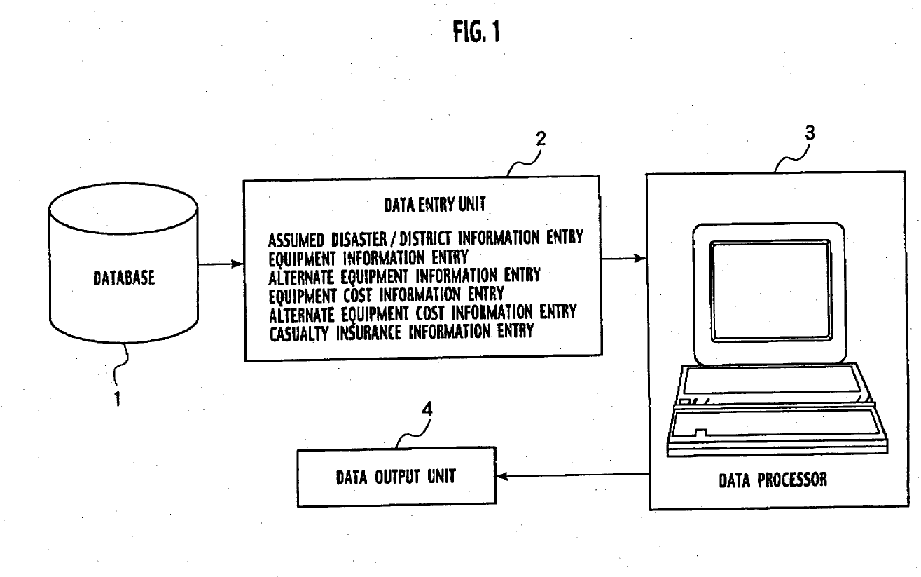

Some embodiments of the present invention will be described below with reference to the drawings. FIG. 1 shows the configuration of a disaster risk assessment system in a first embodiment of the present invention. The functional configuration of the disaster risk assessment system in the first embodiment for assessing the cost of measures at disaster time and its resulting effect or the direct loss amount and the suspension-causing business value loss amount is as shown in FIG. 1. The system comprises a database 1 in which assumed disaster/district information, equipment information, counter-disaster alternate equipment information, equipment cost information, and alternate equipment cost information are stored; a data entry unit 2 via which data on assumed disaster/district information, equipment information, counter-disaster alternate equipment information, equipment cost information, and alternate equipment cost information is entered; a data processor 3 that performs processing and operation; and a data output unit 4 that outputs processed data.

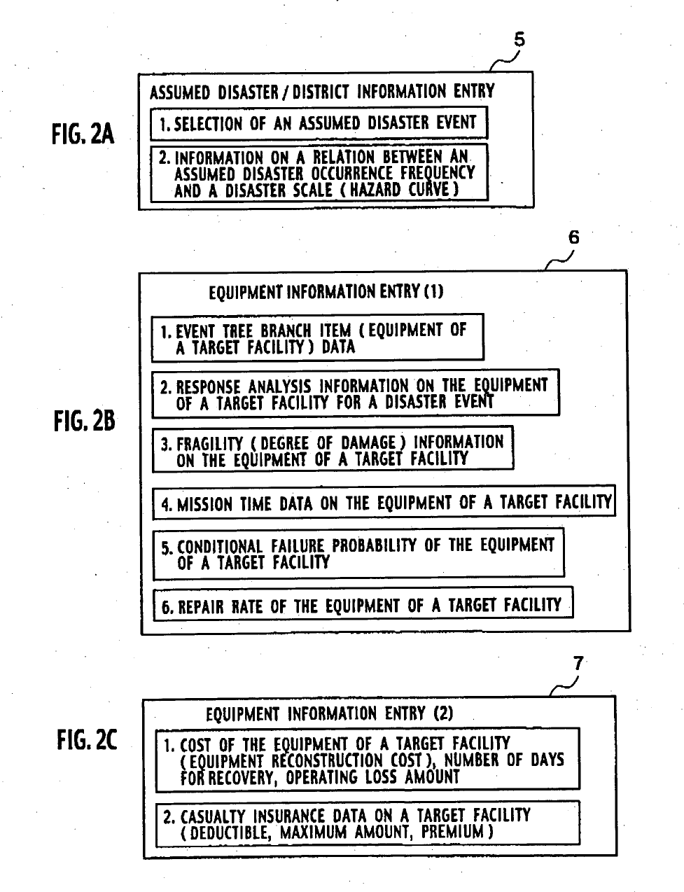

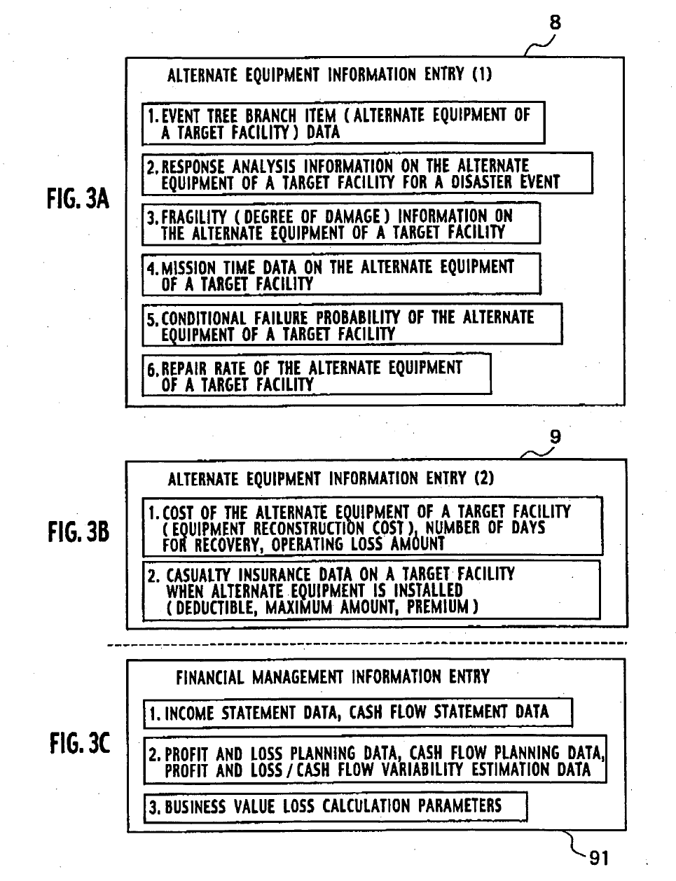

FIG. 2A to FIG. 3C show a list of data entered from the data entry unit 2 of the disaster risk assessment system in this embodiment in which an earthquake is assumed as the disaster. The entry data comprises assumed disaster/district information entry data 5, equipment information entry (1) 6, equipment information entry (2) 7, alternate equipment information entry (1) 8, and alternate equipment information entry (2) 9.

The assumed disaster/district information entry data 5 includes the selection of an assumed disaster event and information on a relation between the assumed disaster occurrence frequency and the disaster scale (hazard curve) such as the one shown in FIG. 5. The equipment information entry (1) 6 includes event tree branch item (equipment of target facility) data, response analysis information on the equipment of a target facility for a disaster event, fragility (degree of damage) information on the equipment of a target facility, mission time data on the equipment of a target facility, conditional failure probability of the equipment of a target facility, and the repair rate of the equipment of a target facility. The equipment information entry (2) 7 includes the cost of the equipment of a target facility (equipment reconstruction cost), number of days for recovery, operating loss amount, and casualty insurance data (deductible, maximum amount, premium) on a target facility.

The alternate equipment information entry (1) 8 includes event tree branch item (alternate equipment of a target facility) data, response analysis information on the alternate equipment of a target facility for a disaster event, fragility (degree of damage) information on the alternate equipment of a target facility, mission time data on the alternate equipment of a target facility, conditional failure probability of the alternate equipment of a target facility, and the repair rate of the alternate equipment of a target facility. The alternate equipment information entry (2) 9 includes the cost of the alternate equipment of a target facility (equipment reconstruction cost), number of days for recovery, operating loss amount, and casualty insurance data (deductible, maximum amount, premium) on a target facility when alternate equipment is installed.

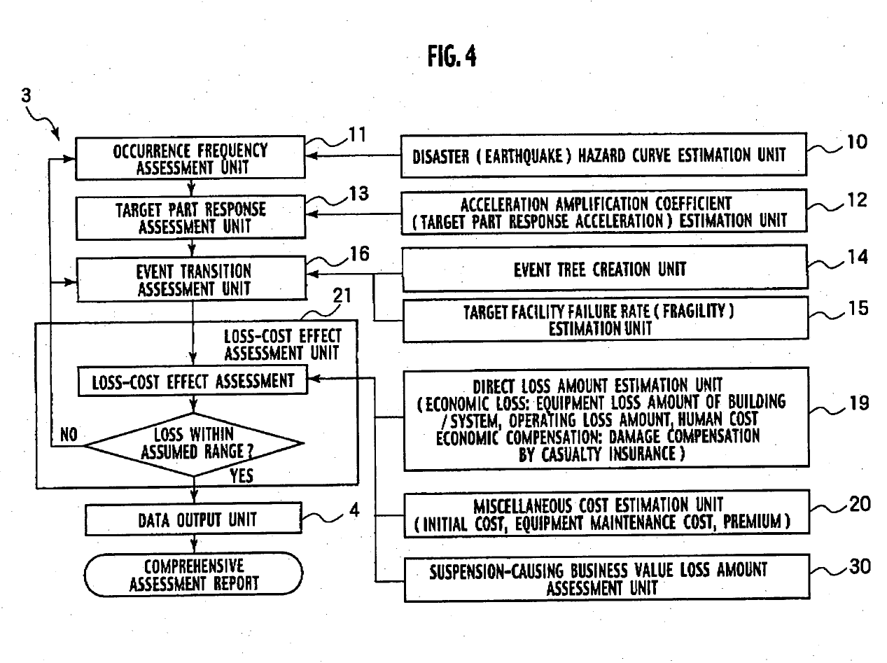

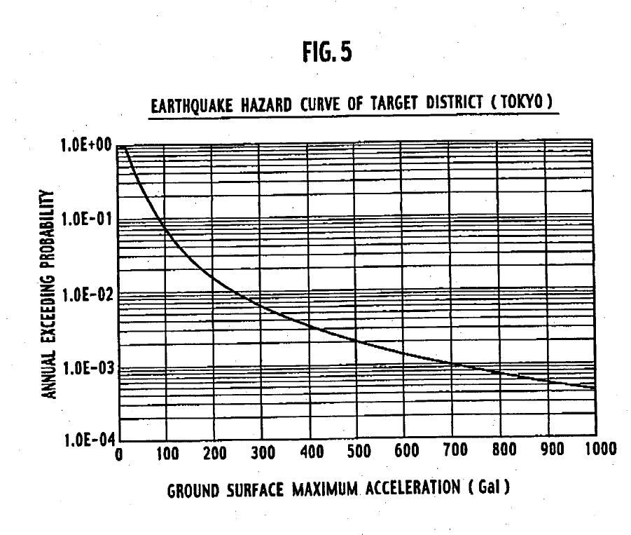

FIG. 4 shows the processing functional configuration of the data processor 3 of the disaster risk assessment system in this embodiment where an earthquake is assumed as the disaster. In this data processor 3, a disaster (earthquake) hazard curve estimation unit 10 estimates a disaster (earthquake) hazard curve, and an occurrence frequency assessment unit 11 assesses the occurrence frequency of a disaster event. After that, an acceleration amplification coefficient (target part response acceleration) estimation unit 12 estimates the acceleration amplification coefficients (target part response acceleration) of the target facility, and a target part response assessment unit 13 assesses the target part response acceleration. Based on the result, an event tree creation unit 14 creates an event tree, and a target facility failure rate (fragility) estimation unit 15 estimates the target facility failure rate (fragility) of an event tree branch event item. The fault tree assessment method is sometimes used to estimate the target facility failure rate (fragility). Next, an event transition assessment unit 16 assesses an event transition and classifies the damage mode after the occurrence of the disaster. Although not shown, a business effect assessment unit may be provided after the event transition assessment unit 16 and, an uncertainty estimation unit that supplies estimation information to the business effect assessment unit may be provided. That is, the uncertainty estimation unit estimates an uncertainty in the data, and the event effect assessment unit makes an event effect assessment to understand the effect that will be caused by the uncertainty in the data.

In addition, from the equipment cost information and the alternate equipment cost information, a direct loss amount estimation unit 19 of the data processor 3 estimates an economic loss, for example, a direct loss amount including the equipment loss amount of the building and systems, operating losses, and human costs. At this time, considering the compensation of a casualty insurance, which is an economic compensation, determined by casualty insurance conditions such as the deductible and the maximum amount, the direct loss amount estimation unit 19 estimates the direct loss amount, from which the compensation has been deducted, that is, the direct loss amount that the business owner must bear. A miscellaneous cost estimation unit 20 estimates miscellaneous costs such as the initial cost, equipment maintenance cost, and premium, and a suspension-causing business value loss amount assessment unit 30 assesses the amount of a business value loss caused by the suspension of business.

A loss-cost effect assessment unit 21 assesses the loss-cost effect and judges if the resulting direct loss amount, the cost of disaster measures, and the suspension-causing business value loss amount are within a range assumed by the business owner. If the loss-cost effect assessment is not within the assumed range as the result of this judgment, the system adjusts the parameters, repeats the assessment and, when the condition specified by the business owner or the decision maker is satisfied, terminates the assessment. When the assessment is terminated, the data output unit 4 outputs the assessment result as a comprehensive assessment report.

FIG. 5 shows an example of an earthquake hazard curve estimated by the disaster (earthquake) hazard curve estimation unit 10 wherein the target district is Tokyo. This data is based on the data in the publications such as “Building load guideline, Building load description” (Architectural Institute of Japan, 1993). Based on such an earthquake hazard curve, the occurrence frequency assessment unit 11 assesses the yearly excess occurrence probability (occurrence frequency) of an earthquake which has a given ground surface maximum acceleration. For example, this hazard curve shows the probability that an earthquake of 200 Gal or higher will occur in one year in the target district, Tokyo, is about 1.5E-02 (=1.5%).

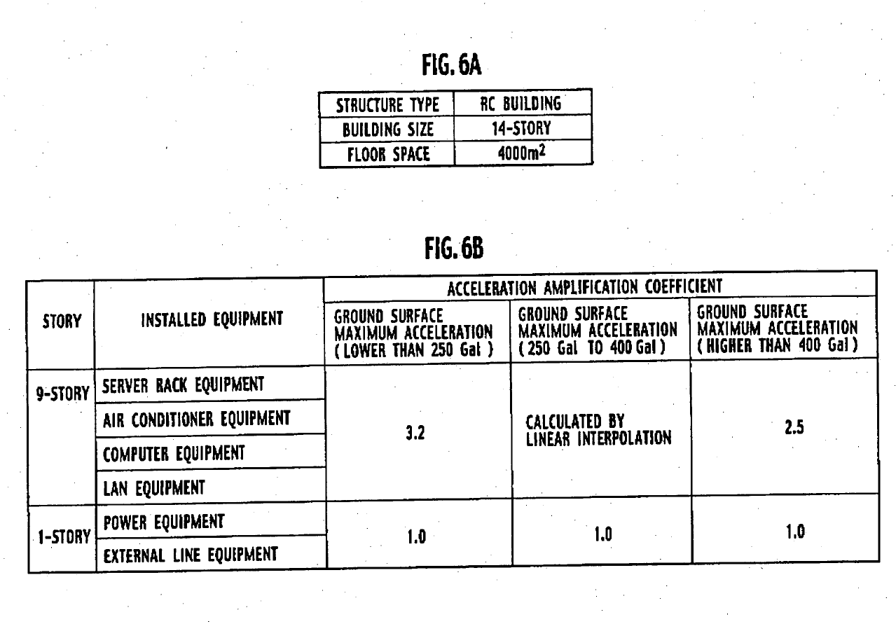

FIG. 6A and FIG. 6B show an example of data used during the processing of the acceleration amplification coefficient (target part response acceleration) estimation unit 12. FIG. 6A shows an example of the outline of an assumed building, and FIG. 6B shows the configuration of equipment installed in the building and the estimated acceleration amplification coefficients. The example shows that, when an earthquake of 250 Gal or lower is recorded in a 14-story RC building with the floor space of 4000 m², the equipment on the first floor is influenced by the same intensity (=1.0) and the equipment on the ninth floor is influenced by the intensity that is amplified 3.2 times. When an earthquake occurs, the target part response assessment unit 13 assesses the target part response acceleration based on the acceleration amplification coefficients.

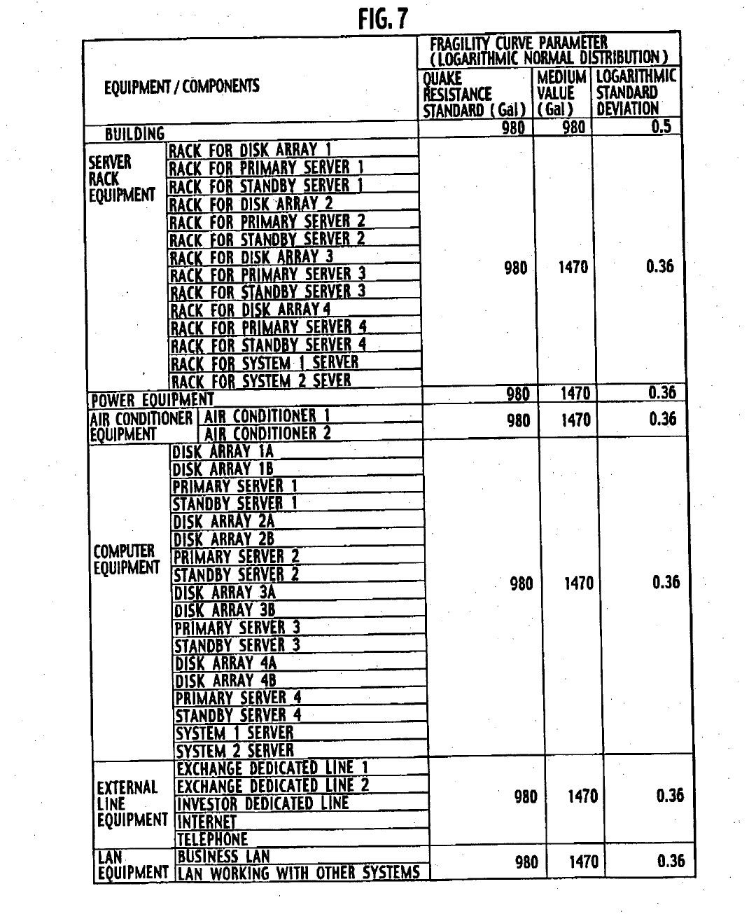

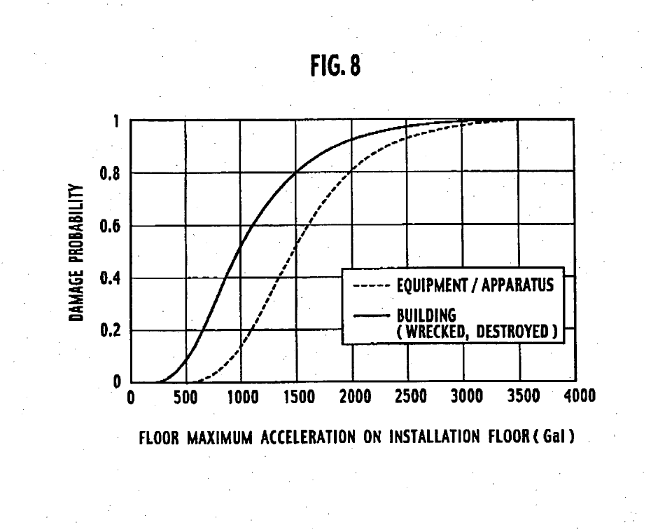

FIG. 7 shows an example of parameters of the fragility (degree of damage) curve of a building and equipment/apparatus that are used when the target facility failure rate (fragility) estimation unit 15 estimates the target equipment failure rate (fragility) of an event tree branch event. In this example, the logarithmic normal distribution is assumed using two parameters, that is, a medium value and a logarithmic standard deviation. FIG. 8 is a graph showing the fragility (degree of damage) curve of the building (top curve) and the equipment/apparatus (bottom curve) when the parameters shown FIG. 7 are used. For example, when the floor maximum acceleration of the floor on which the equipment is installed is 1500 Gal, the damage probability of the building is 80% and the damage probability of the equipment/apparatus is about 53%.

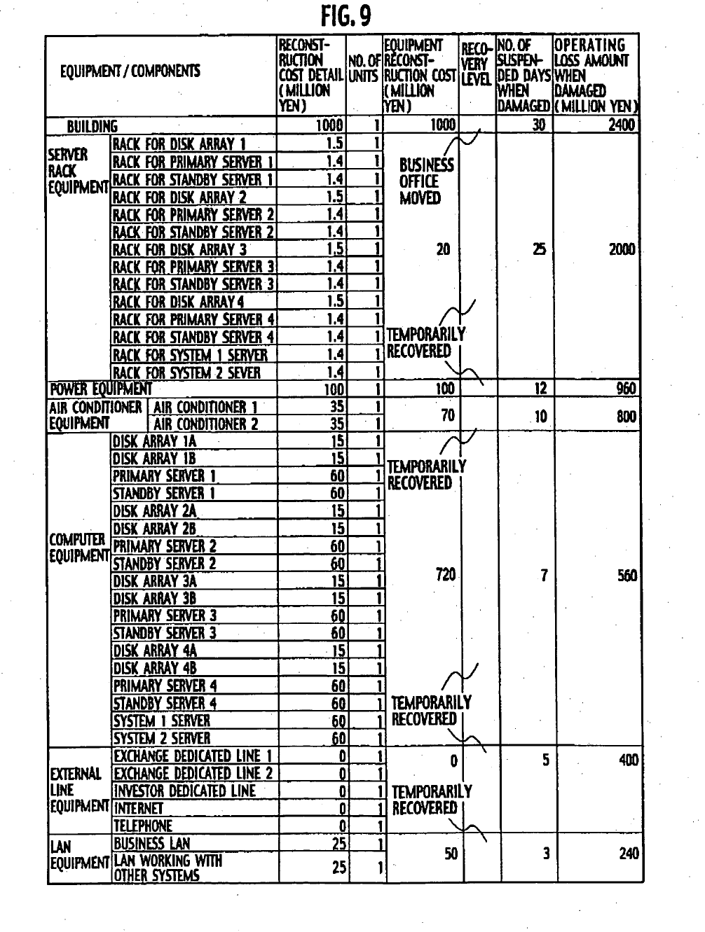

FIG. 9 shows an example of data on the equipment reconstruction cost, number of days of suspension (number of days for recovery), and operating loss amount that is used by the direct loss amount estimation unit 19 during processing as the equipment cost information and the alternate equipment cost information. In this example, the operating loss amount per suspension day is ¥80,000,000 assuming that the annual gross profit is ¥20,000,000,000.

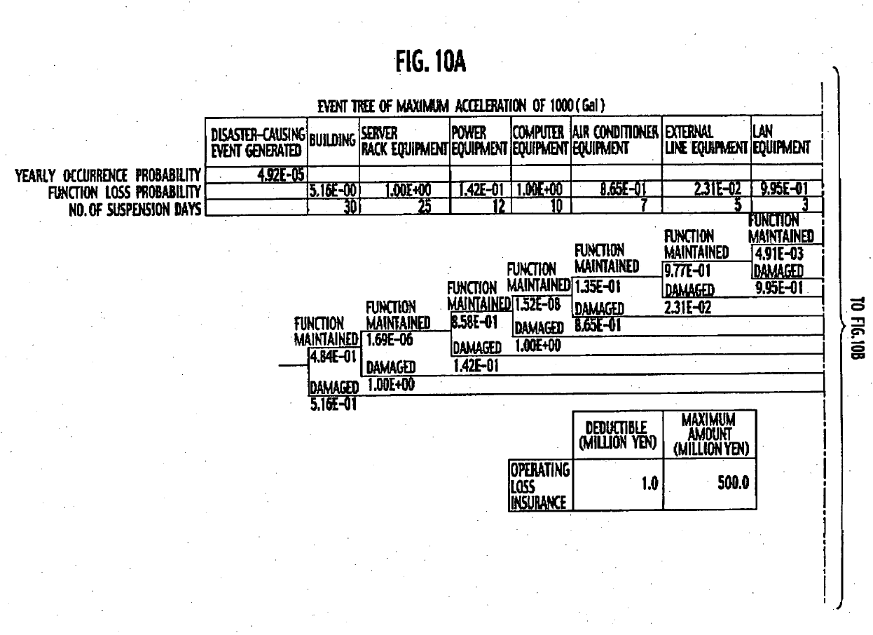

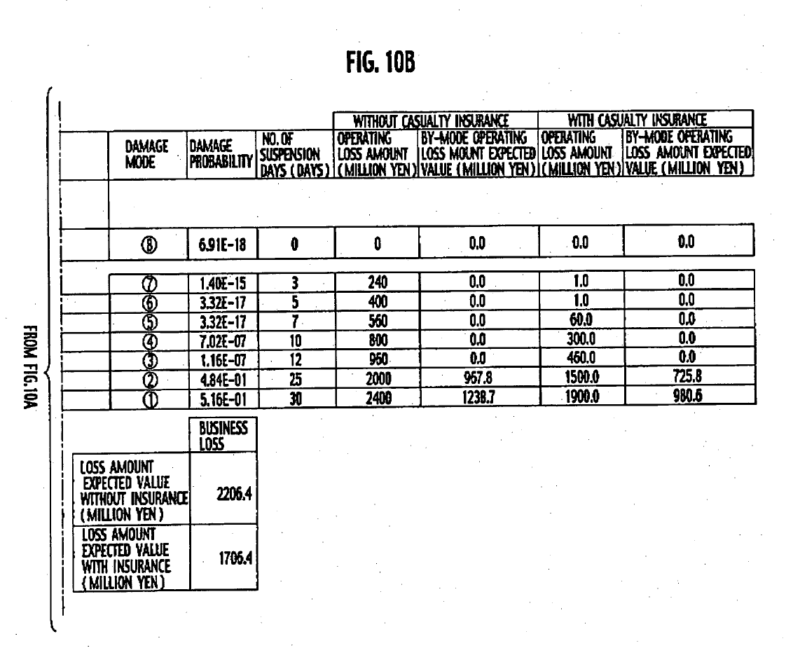

FIGS. 10A and 10B show an example of an event tree of operating losses created by the user using the event tree creation unit 14. In this example, the damage mode is divided into eight: (1) damage mode in which the building is wrecked or destructed, the equipment is destroyed, and the business service is stopped, (2) damage mode in which the server racks are fallen down, the computing function is suspended because the stored servers are wrecked, and the business service is suspended, (3) damage mode in which the power equipment is wrecked, the computer equipment, air conditioner equipment, and LAN equipment are stopped urgently, and the business service is stopped, (4) damage mode in which a part of the computer equipment is wrecked, the computing function is stopped, and the business service is stopped, (5) damage mode in which the air conditioner equipment is wrecked, the maximum temperature for the computer operation cannot be maintained, the computer equipment is stopped urgently, and the business service is stopped, (6) damage mode in which the external line equipment is wrecked, the communication with external world is stopped, and the business service is stopped, (7) damage mode in which the LAN equipment is wrecked, the in-facility communication is stopped, and the business service is stopped, and (8) damage mode in which the minimum business service is maintained.

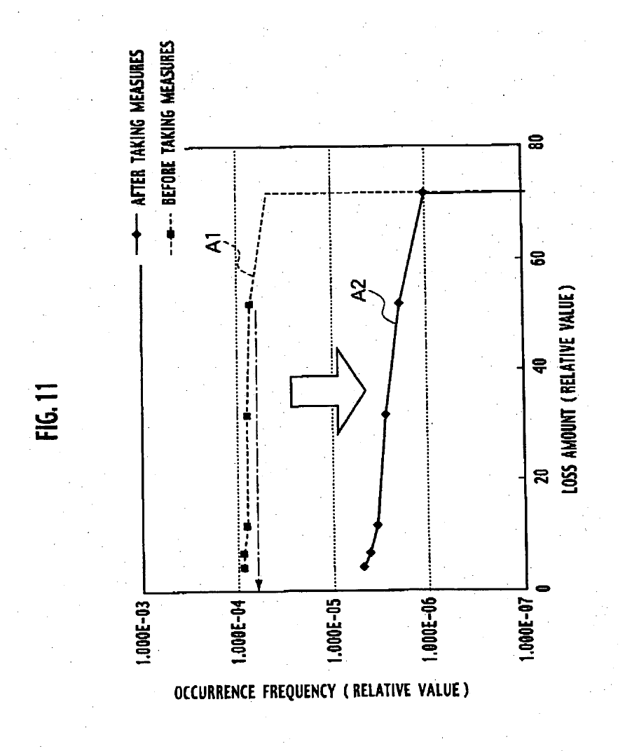

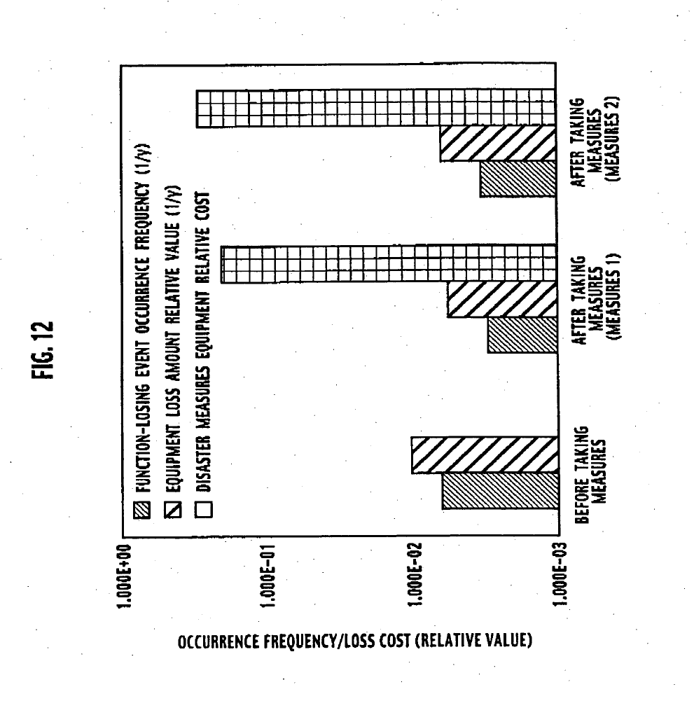

FIG. 11 and FIG. 12 show examples of output, which show a comparison between the cost of measures and the effect produced by the data output unit 4 during the processing of the disaster risk assessment system in this embodiment. FIG. 11 shows a relation, in relative values, between a loss amount and the occurrence frequency of a function-losing event corresponding to the loss amount before and after measures are taken for a disaster that occurs. The loss amount before taking measures is represented by A1, and the loss amount after taking measures is represented by A2. FIG. 12 shows a relation among the occurrence frequency of a function-losing event, an equipment loss amount relative value, and a disaster measures equipment relative cost before and after measures are taken. When taking measures for an assumed disaster event, the business owner and the decision maker can use those relations in advance to understand the cost versus effect.

In this way, the disaster risk assessment system in this embodiment of the present invention allows the user to assess an amount of reduction in the loss amount that is estimated for the measures to be taken for an assumed disaster, thereby helping the user in the decision making of planning, assessment, and execution of the disaster measures.

As described above, the disaster risk assessment system in this embodiment allows the user to assess the direct loss amount, such as the loss amount of the equipment and property at disaster time, or the disaster measures equipment cost. The system can also assess the difference between the business owner's disaster-time direct loss amount of the current equipment and the disaster-time direct loss amount of the equipment after the measures are taken and compares the resulting difference with the disaster measures equipment cost to provide the business owner with decision making information on the disaster measures. In addition, the system receives an event tree branch item (target facility) sequence, initial event occurrence frequency, information on a response to a target facility when an event occurs in the current equipment and multiple pieces of counter-disaster equipment of an event tree target facility, event occurrence time damage probability, mission time, conditional failure probability, and the cost of the current equipment and counter-disaster equipment of the event tree target facility and then compares the function-losing event occurrence frequency and facility loss amount of the current equipment with the function-losing event occurrence frequency and facility loss amount after the measures are taken to provide a business owner with decision making information on the equipment measures.

Next, the operating loss amount expected value, with the casualty insurance compensation taken into consideration, is calculated as follows. The condition for the business casualty insurance is that, only when the operating loss amount exceeds D, the excess amount is compensated by the casualty insurance for one accident with the maximum amount of L where D is the deductible and L is the maximum amount. In this case, the operating loss amount yᵢ of the damage mode i, with the casualty insurance compensation taken into consideration, is calculated by expression (4) where the operating loss amount without casualty insurance is sᵢ.

$${y}_{i} = \{ \begin{matrix}{s}_{i} & ( 0 < {s}_{i} < D ) \\ D & ( D \leq {s}_{i} < L ) \\ {s}_{i} - ( L - D ) & ( L \leq {s}_{i} < ∞ )\end{matrix} \qquad ( 4 )$$

In this case, the operating loss amount expected value Y, with the casualty insurance compensation taken into consideration, is calculated by expression (5) where Qᵢ is the damage probability of the damage mode i and M is the total number of damage modes.

$$Y = {\sum }_{i = 1}^{M} {Q}_{i} {y}_{i} \qquad ( 5 )$$

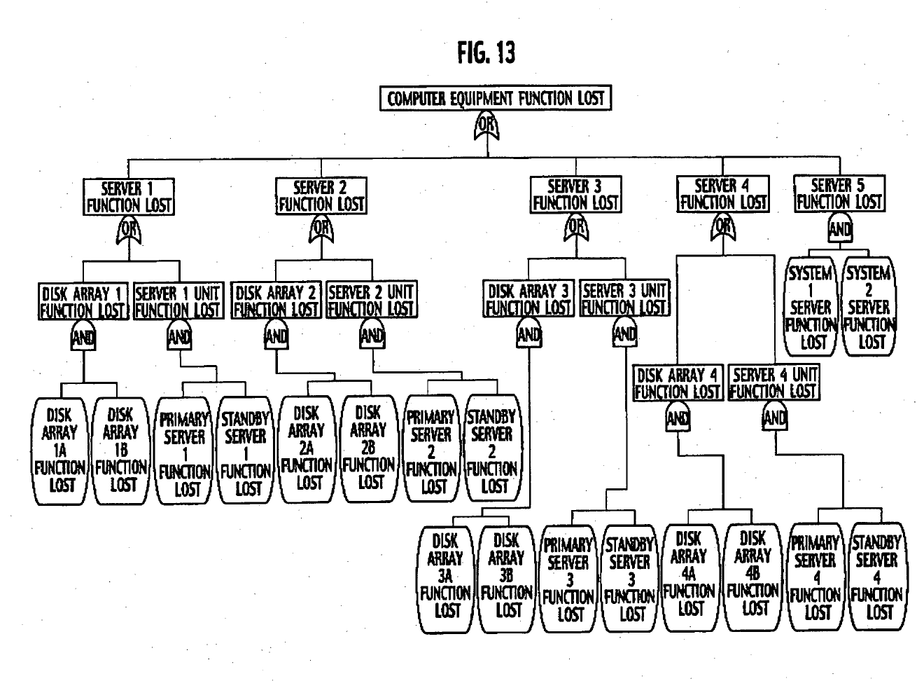

FIG. 13 shows an example of a fault tree that is used by the target facility failure rate (fragility) estimation unit 15 to estimate the target facility failure rate (fragility) of event tree branch event items. More specifically, this example shows a fault tree used to assess the target facility failure rate (function loss probability) of the computer equipment. An OR event is an event wherein, when one of the lower-level events has lost its function, the upper-level event loses its function. The function loss probability q of an OR event is calculated by expression (6) through Boolean algebra.

$$q = 1 - {\prod }_{j = 1}^{N} ( 1 - {q}_{i} ) \qquad ( 6 )$$

where, qⱼ is the function loss probability of a lower-level event j and N is the total of lower-level events. An AND event is an event wherein, when all lower-level events have lost their functions, the higher-level event loses its function. The function loss probability q of an AND event is calculated by expression (7) through Boolean algebra.

$$q = {\prod }_{j - 1}^{N} {q}_{i} \qquad ( 7 )$$

For a fault tree such as the one shown in FIG. 13, the function loss probability (target facility failure rate) of the top event (event tree branch event item) of the fault tree is calculated through Boolean algebra by using the function loss probability rates (target facility failure rates) of the bottom level events (building and equipment/apparatus) given in FIG. 7 and FIG. 8.

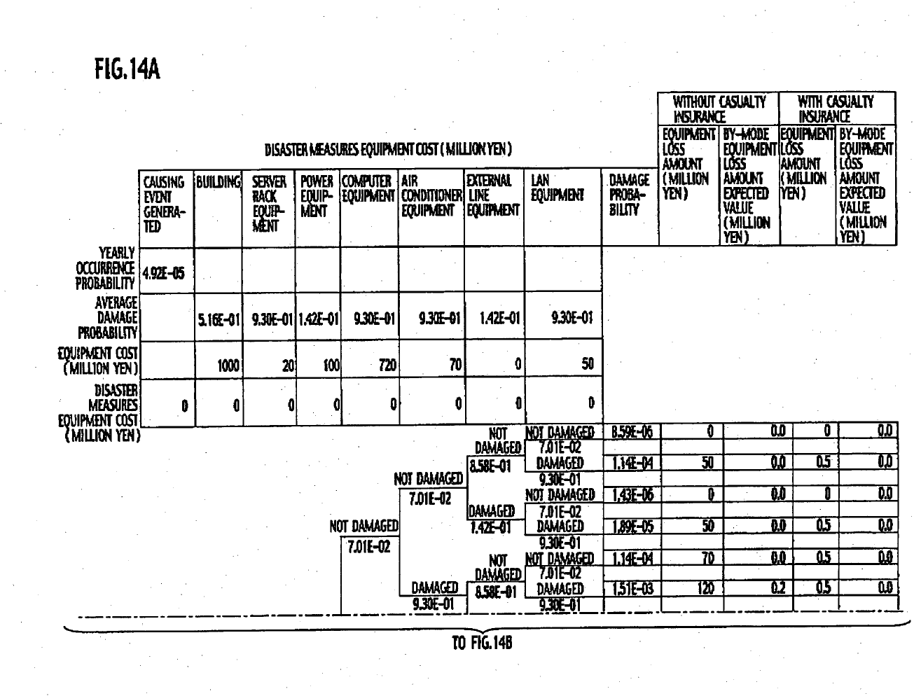

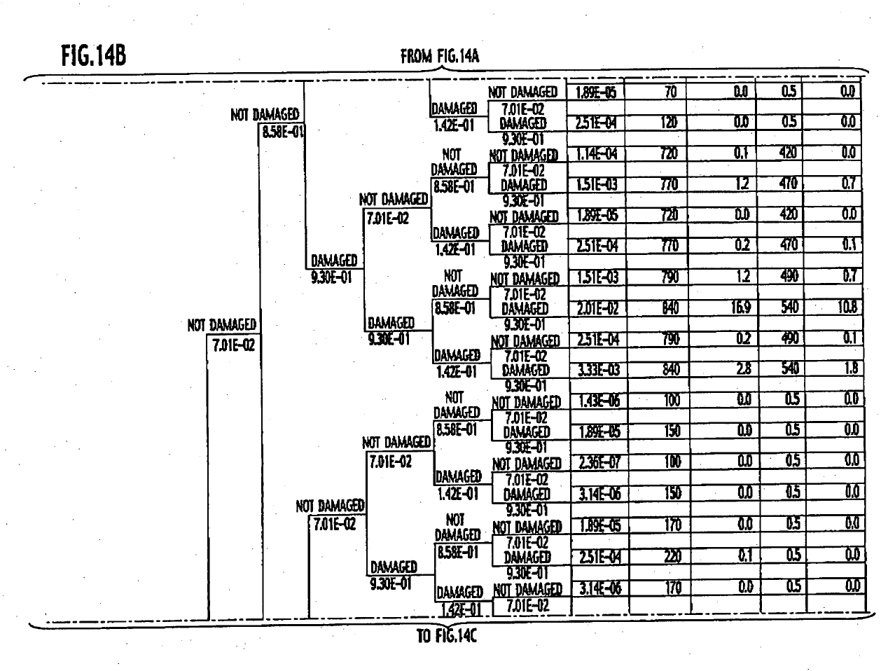

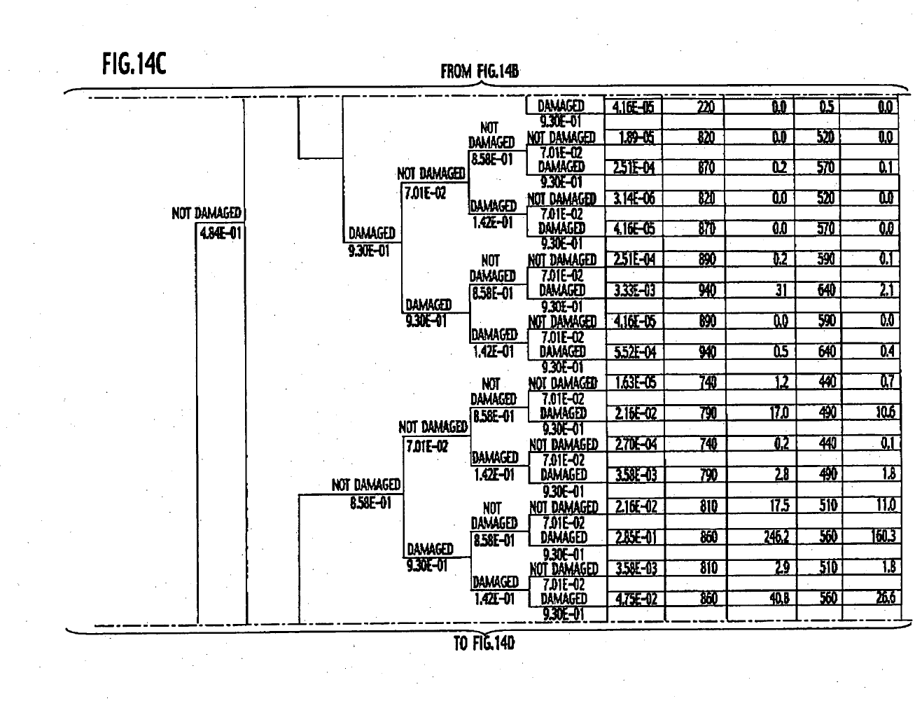

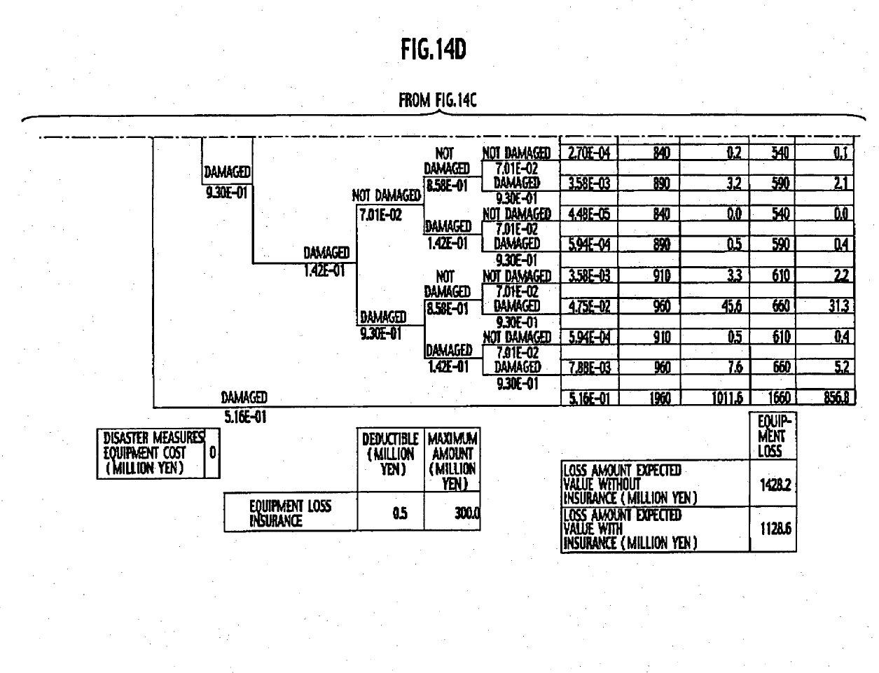

FIG. 14A to FIG. 14D show an example of an event tree of equipment losses created by the event tree creation unit 14. In this example, it is assumed that all the equipment of the target facility is destroyed when the building is wrecked or destroyed and that the stored servers are wrecked when the server racks are fallen and damaged.

The equipment loss amount expected value, with the casualty insurance compensation taken into consideration, is calculated as follows. The condition for the equipment casualty insurance is that, only when the equipment loss amount exceeds D, the excess amount is compensated by the casualty insurance for one accident with the maximum amount of L where D is the deductible and L is the maximum amount. In this case, the equipment loss amount yᵢ of the damage mode i, with the casualty insurance compensation taken into consideration, is calculated by expression (8) where the equipment loss amount without casualty insurance is sᵢ.

$${y}_{i} = \{ \begin{matrix}{s}_{i} & ( 0 < {s}_{i} < D ) \\ D & ( D \leq {s}_{i} < L ) \\ {s}_{i} - ( L - D ) & ( L \leq {s}_{i} < ∞ )\end{matrix} \qquad ( 8 )$$

In this case, the equipment loss amount expected value Y, with the casualty insurance compensation taken into consideration, is calculated by expression (9) where Qᵢ is the damage probability of the damage mode i and M is the total number of damage modes.

$$Y = {\sum }_{i = 1}^{M} {Q}_{i} {y}_{i} \qquad ( 9 )$$

The target facility failure rate (fragility) q_{u]} of equipment j, which is an event tree branch event item of the equipment loss, for example, the average damage probability generated by weighting the damage probability qₖ of the component apparatus k of the equipment j by the rate of its reconstruction cost Cₖ, is calculated by expression (10)

$${q}_{Uj} = {\sum }_{k = 1}^{m} {q}_{k} \frac{{C}_{k}}{{\sum }_{k = 1}^{m} {C}_{k}} \qquad ( 10 )$$

where the total of component apparatuses of the equipment j is m.

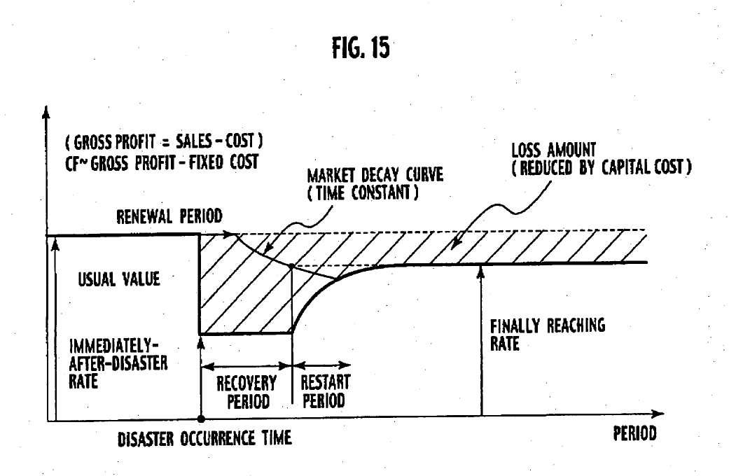

Next, how the disaster risk assessment system in this embodiment assesses a business value loss amount caused by a suspension at disaster time will be described. FIG. 15 shows an example of a change in the gross profit obtained from a business that is suspended because a disaster occurs and the business is suspended. When a disaster occurs and there is a loss of the equipment, property, and persons, the business activity is interrupted and the gross profit is either decreased to “usual value×immediately-after-disaster rate” or lost. If there is a stock of merchandises or products, the gross profit may be decreased, based on some time function, after the disaster occurrence time. It is assumed that the business activity or the production operation is stopped before the damaged equipment and property are recovered and that the gross profit remains at the level of the value immediately after the disaster. As the damaged equipment and property are recovered, the operation, business, and production activity are gradually restarted after the recovery period with the gross profit recovered to a given level (gross profit usual value×finally reaching rate). It is assumed that the finally reaching rate of the gross profit is dependent on the recovery time and that the rate is decreased according to the market loss curve that is the exponential function of a time constant.

As described above, a temporary suspension of the business activity due to the occurrence of a disaster involves not only a loss during the recovery period but also a risk of permanent loss due to a decrease in the market share. The loss amount at various points in future time is reduced by the capital cost, and the sum of their current values is assessed as the amount of suspension risk caused by the occurrence of a disaster. The current value of the amount, represented by the size of the shaded area (Assessment period×Reduction in gross profit in each period) in FIG. 15, is the business value loss amount caused by the suspension. That is, the current value of the suspension-causing business value loss amount for a given number of suspension days at disaster occurrence time is given, for example, by expression (11).

$$v = {W}_{0} {\sum }_{k = 0}^{n} \frac{1 - {γ}_{k}}{{( 1 + R )}^{k}} \qquad ( 11 )$$

where, v is the current value of the suspension-causing business value loss amount at the time a disaster occurs, n is the number of years in the period for which assessment is made, W₀ is the value of gross profit immediately before the disaster, R is the capital cost, γₖ is the ratio of the gross profit value expected in k years from the occurrence of the disaster to the gross profit value immediately before the disaster (k=0, 1, 2, . . . , n).

A disaster potentially occurs any time in future. Therefore, given the yearly disaster occurrence probability of a disaster such as an earthquake, the suspension-causing business value loss amount in an assessment period can be calculated for a given number of suspension days, for example, by expression (12),

$$v = {\sum }_{j = 0}^{n} {p}_{j} {\sum }_{k = j}^{n} {W}_{k} \frac{1 - {γ}_{k j}}{{( 1 + R )}^{k}} \qquad ( 12 )$$

where, v is the expected value of the suspension-causing business value loss amount, n is the number of years in the period for which assessment is made, Pⱼ is the disaster occurrence probability in j years (j=0, 1, 2, . . . , n),Wₖ is the value of gross profit immediately before the disaster in k years (k=0, 1, 2, . . . , n), R is the capital cost, and γₖⱼ is the ratio of the gross profit value expected in k years after the disaster that occurs in j years to the gross profit value immediately before the disaster.

Although the “gross profit=sales−cost” is used as the management index to assess the business value loss amount in the above example, any management index may be used including the expected cash flow, business profit, and current profit. It is possible to assume that the value of the management index such as the gross profit will be increased or decreased. It is also possible to use any function for the market loss curve or for the gross profit increase after the recovery from the disaster and to calculate the business value loss amount by estimating the value of management index for each of the future years. For a widespread disaster, if it is possible to increase the market share by restarting the business activity sooner than competitors, a curve simulating an increase in the management index value, such as the profit, may be used instead of the market decay curve described above. Because the future value of a management index such as the profit is uncertain, it is also possible to give the probability density distribution for building a system that calculates and displays the probability density distribution of the suspension-causing business value loss amount calculated by expression (12).

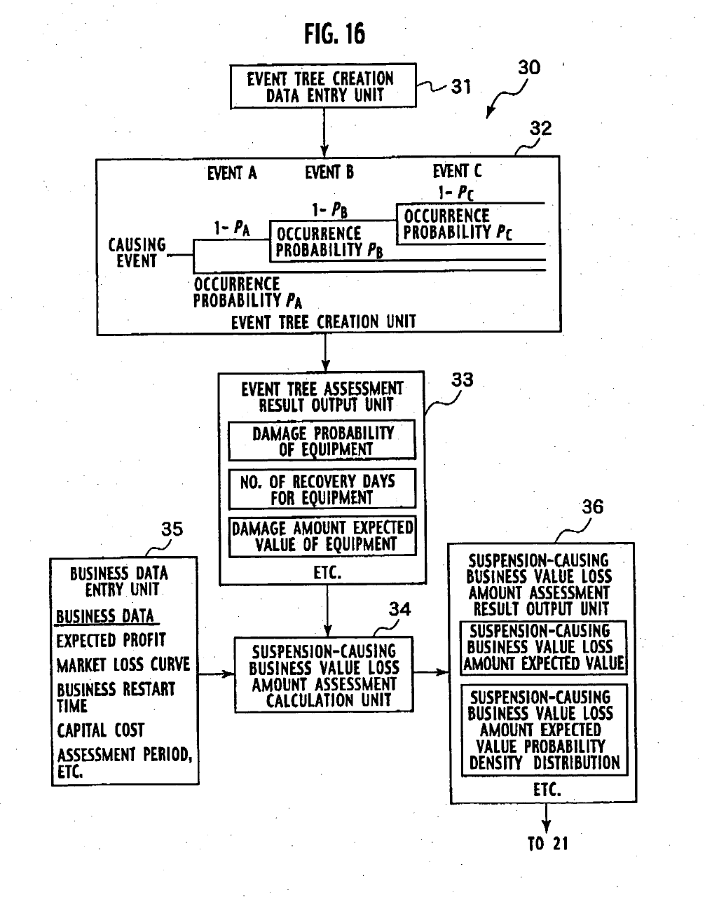

Expression (12) calculates the suspension-causing business value loss amount for a given number of suspension days. However, because the number of suspension days depends on a loss event that is caused by the occurrence of a disaster, the number of suspension days when a disaster occurs and its occurrence probability are necessary. The number of suspension days and its occurrence probability are calculated by creating an event tree, such as the one shown in FIG. 16, that represents the loss of the equipment and property caused by the occurrence of a disaster. The number of suspension days depends on the recovery period of the damaged equipment and property. The probability with which the number of suspension days is generated is given by the loss probability according to the degree of loss of the equipment and property necessary for the business activity. The loss events obtained in this way are rearranged in the descending order of occurrence probabilities and, from the suspension-causing business value loss amount generated for the loss event, the expected value of the business value loss amount is assessed, for example, by expression (13). Here, the business value loss amount Vₖ given by the loss event with the k-th highest occurrence probability is calculated by expression (12) using the expected number of suspension days.

$$V = {\sum }_{k = 0}^{n} {p}_{k} Δ {v}_{k} \qquad ( 13 )$$

where,

V: Expected value of suspension-causing business value loss amount

n: No. of assumed loss events

pₖ: Occurrence probability of k-th loss event (pₖ≦Pₖ₋₁, K=1, 2, . . . , n)

Δv₀=v₀

Δvₖ=vₖ−vₖ₋₁ (vₖ≧vₖ₋₁, k=1, 2, . . . , n)

Δvₖ=0 (vₖ<vₖ₋₁, k=1, 2, . . . , n)

v: Business value loss amount for k-th loss event

FIG. 16 shows the detail of the suspension-causing business value loss amount assessment unit 30 that characterizes this embodiment. The suspension-causing business value loss amount assessment unit 30 comprises an event tree creation data entry unit 31, an event tree creation unit 32, an event tree assessment result output unit 33, a suspension-causing business value loss amount assessment calculation unit 34, a business data entry unit 35, and a suspension-causing business value loss amount assessment result output unit 36.

The event tree creation data entry unit 31 receives data for use in creating an event tree; for example, loss event and equipment/property data (current value, recovery period, arrangement, loss probability, and so on) disaster causing event data, and cause generation probability, and soon. Based on this data, the event tree creation unit 32 creates an event tree and analyzes it. The event tree assessment result output unit 33 receives the output data from the event tree creation unit 32 and outputs and displays the loss amount of the equipment, loss occurrence probability, recovery period, total loss amount expected value, business recovery cost, or the occurrence probability of assumed loss events. If necessary, it is possible to add means, which analyze the physical phenomenon of the events entered into the event tree, to the suspension-causing business value loss amount assessment unit 30 to assess the loss amount of the equipment, loss occurrence probability, recovery period, total loss amount expected value, business recovery cost, or the occurrence probability of assumed loss events.

The suspension-causing business value loss amount assessment calculation unit 34 receives data output from the event tree assessment result output unit 33 and data, such as the expected profit, market loss curve, business restart time, capital cost, and assessment period from the business data entry unit 35 into which such data is entered, and performs assessment calculation for the suspension-causing business value loss amount using expression (12) and expression (13). The suspension-causing business value loss amount assessment result output unit 36 outputs and displays the calculated result such as the suspension-causing business value loss amount expected value. This result is sent to the loss-cost effect assessment unit 21.

For an earthquake disaster, it is also possible that, with the probability pₖ in expression (13) given, the suspension risk assessment calculation unit 34 of the suspension-causing business value loss amount assessment unit 30 performs suspension risk assessment calculation using the hazard curve for the maximum acceleration predetermined for each assessment point and the fragility curve representing the relation between the assumed loss event occurrence probability and the response acceleration.

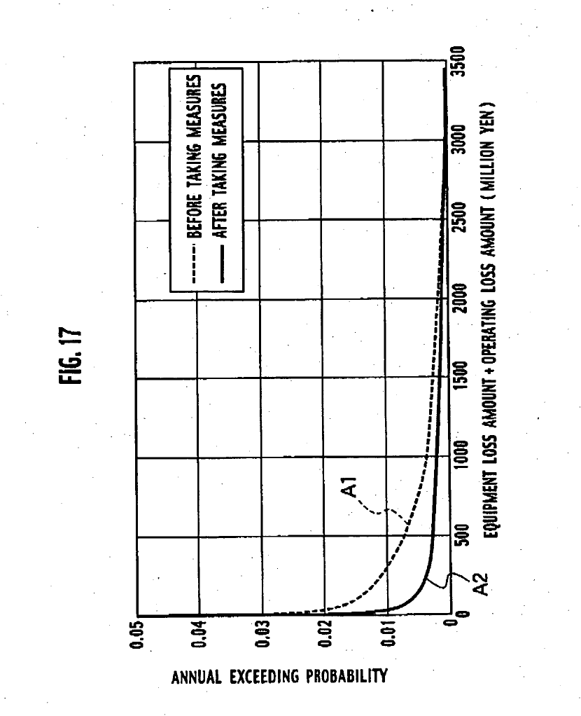

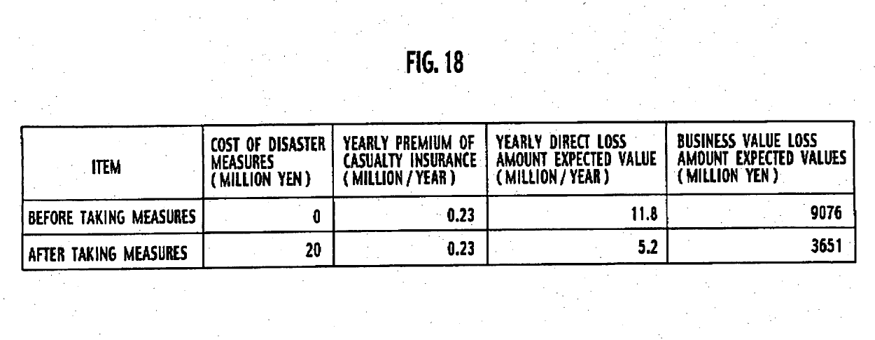

FIG. 17 and FIG. 18 show an example of cost versus effect comparison of the disaster measures that is obtained from the data output unit 4 during the processing of the disaster risk assessment system in this embodiment. The direct loss amount expected value (expected value of the sum of the equipment loss amount and the operating loss amount) shown in this example is the direct loss amount expected value from which the amount compensated by the casualty insurance has been deducted. The compensation is determined according to the casualty insurance condition such as the deductible or the maximum amount. FIG. 17 shows a relation, before and after taking measures, between a direct loss amount expected value and the frequency of occurrence of a function-losing event that causes the loss amount when a disaster occurs. A1 represents the direct loss amount expected value before taking measures, and A2 represents that after taking measures. FIG. 18 shows a relation, before and after taking measures, among the cost of disaster measures, yearly premium of casualty insurance, yearly direct loss amount expected value, and business value loss amount expected value when a disaster occurs. When taking measures for an assumed disaster event in advance, the business owner and the decision maker can use those relations to understand the cost versus effect in advance.

The disaster risk assessment system in the first embodiment with the configuration described above allows a business owner to perform a sequence of processing to adequately assess a disaster risk associated with the occurrence of a disaster from an economic point of view. In doing so, this system allows the business owner to assess the direct loss amount, from which the amount compensated by a casualty insurance has been deducted, that is, the direct loss amount that the business owner must bear, with the casualty insurance condition such as the deductible and the maximum amount taken into consideration. The disaster risk assessment system also provides decision-making information on disaster measures that allows the business owner to make an economically feasible, appropriate disaster measures plan and to estimate the cost of the measures.

Next, a disaster risk assessment system in a second embodiment of the present invention will be described. The system in this embodiment, a modification of the first embodiment of the present invention, is characterized in that a business owner takes out a business casualty insurance but not an equipment casualty insurance.

The functional configuration is similar to that of the first embodiment with a difference from the first embodiment only in the method for calculating the equipment loss amount expected value. The following describes only the method for calculating the equipment loss amount expected value, without repeating the other functional configuration that has already been described.

The equipment loss amount expected value in the disaster risk assessment system in the second embodiment is calculated as follows. The equipment loss amount expected value S is calculated by expression (14),

$$S = {\sum }_{i = 1}^{M} {Q}_{i} {s}_{i} \qquad ( 14 )$$

where sᵢ is the equipment loss amount in the damage mode i, Qᵢ is the damage probability in the damage mode i, and M is the total number of damage modes.

As described above, the disaster risk assessment system in the second embodiment allows a business owner to adequately assess a disaster risk associated with the occurrence of a disaster from an economic point of view. In doing so, when the business owner takes out a business casualty insurance but not an equipment casualty insurance, this system allows the business owner to assess the direct loss amount, from which the amount compensated by the business casualty insurance has been deducted, that is, the direct loss amount that the business owner must bear, with the business casualty insurance condition such as the deductible and the maximum amount taken into consideration. The disaster risk assessment system also provides decision-making information on disaster measures that allows the business owner to make an economically feasible, appropriate disaster measures plan and to estimate the cost of the measures.

Next, a disaster risk assessment system in a third embodiment of the present invention will be described. The system in this embodiment, a modification of the first embodiment of the present invention, is characterized in that a business owner takes out an equipment casualty insurance but not a business casualty insurance.

The functional configuration is similar to that of the first embodiment with a difference from the first embodiment only in the method for calculating the operating loss amount expected value. The following describes only the method for calculating the operating loss amount expected value, without repeating the other functional configuration that has already been described.

The operating loss amount expected value in the disaster risk assessment system in the third embodiment is calculated as follows. The operating loss amount expected value S is calculated by expression (15),

$$S = {\sum }_{i = 1}^{M} {Q}_{i} {s}_{i} \qquad ( 15 )$$

where sᵢ is the operating loss amount in the damage mode i, Qᵢ is the damage probability in the damage mode i, and M is the total number of damage modes.

As described above, the disaster risk assessment system in the third embodiment allows a business owner to adequately assess a disaster risk associated with the occurrence of a disaster from an economic point of view. In doing so, when the business owner takes out an equipment casualty insurance but not a business casualty insurance, this system allows the business owner to assess the direct loss amount, from which the amount compensated by the equipment insurance has been deducted, that is, the direct loss amount that the business owner must bear, with the equipment insurance condition such as the deductible and the maximum amount taken into consideration. The disaster risk assessment system also provides decision-making information on disaster measures that allows the business owner to make an economically feasible, appropriate disaster measures plan and to estimate the cost of the measures.

Next, a disaster risk assessment system in a fourth embodiment of the present invention will be described. The system in this embodiment is characterized in that, in addition to the functions of the first embodiment of present invention, the system in this embodiment further comprises a function for assessing the premium of the casualty insurance for use when the deductible or the maximum amount of the casualty insurance is changed.

The functional configuration of the disaster risk assessment system in this embodiment for assessing the disaster-time cost of measures and its effect, direct loss amount and suspension-causing business value loss amount, and casualty insurance premium assessment is the same as that of the first embodiment shown in FIG. 1. That is, the system comprises a database 1 in which assumed disaster/district information, equipment information, counter-disaster alternate equipment information, equipment cost information, and alternate equipment cost information are stored; a data entry unit 2 via which data on assumed disaster/district information, equipment information, counter-disaster alternate equipment information, equipment cost information, and alternate equipment cost information is entered; a data processor that performs processing and operation; and a data output unit 4 that outputs processed data.

A list of data entered from the data entry unit 2 of the disaster risk assessment system in this embodiment, in which an earthquake is assumed as the disaster, is the same as that of the first embodiment shown in FIG. 2A to FIG. 3C. The entry data comprises assumed disaster/district information entry data 5, equipment information entry (1) 6, equipment information entry (2) 7, alternate equipment information entry (1) 8, and alternate equipment information entry (2) 9.

The assumed disaster/district information entry data 5 includes the selection of an assumed disaster event and information on a relation between the assumed disaster occurrence frequency and the disaster scale (hazard curve). The equipment information entry (1) 6 includes event tree branch item (equipment of target facility) data, response analysis information on the equipment of a target facility for a disaster event, fragility (degree of damage) information on the equipment of a target facility, mission time data on the equipment of a target facility, conditional failure probability of the equipment of a target facility, and the repair rate of the equipment of a target facility. The equipment information entry (2) 7 includes the cost of the equipment of a target facility (equipment reconstruction cost), number of days for recovery, operating loss amount, and casualty insurance data (deductible, maximum amount, premium) on a target facility. The alternate equipment information entry (1) 8 includes event tree branch item (alternate equipment of a target facility) data, response analysis information on the alternate equipment of a target facility for a disaster event, fragility (degree of damage) information on the alternate equipment of a target facility, mission time data on the alternate equipment of a target facility, conditional failure probability of the alternate equipment of a target facility, and the repair rate of the alternate equipment of a target facility. The alternate equipment information entry (2) 9 includes the cost of the alternate equipment of a target facility (equipment reconstruction cost) number of days for recovery, operating loss amount, and casualty insurance data (deductible, maximum amount, premium) on a target facility when alternate equipment is installed.

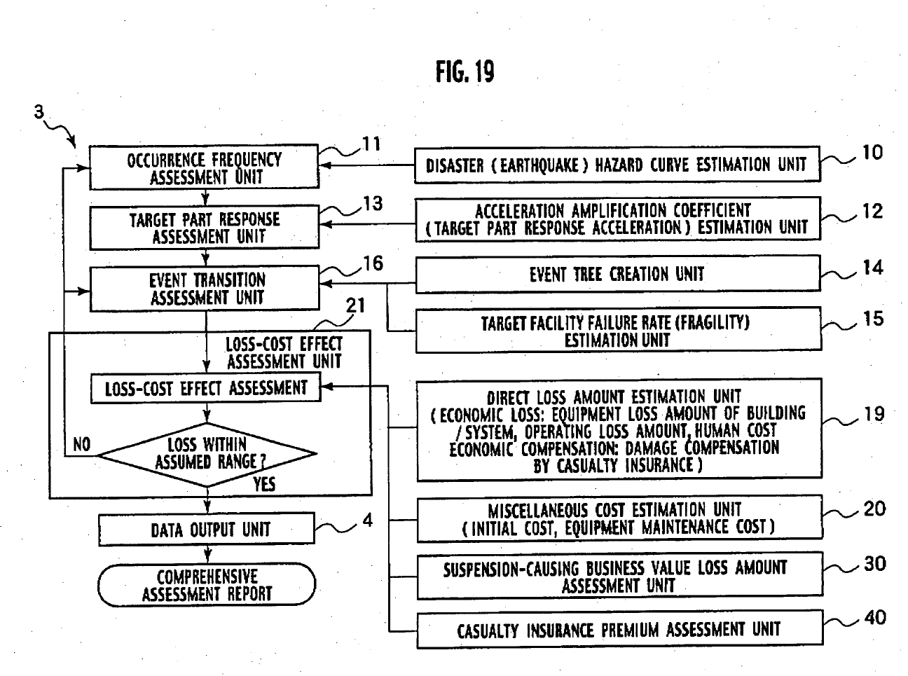

FIG. 19 shows the processing functional configuration of the data processor 3 of the disaster risk assessment system in this embodiment where an earthquake is assumed as the disaster. In this data processor 3, a disaster (earthquake) hazard curve estimation unit 10 estimates a disaster (earthquake) hazard curve, and an occurrence frequency assessment unit 11 assesses the occurrence frequency of a disaster event. After that, an acceleration amplification coefficient (target part response acceleration) estimation unit 12 estimates the acceleration amplification coefficients (target part response acceleration) of the target facility, and a target part response assessment unit 13 assesses the target part response acceleration. Based on the result, an event tree creation unit 14 creates an event tree, and a target facility failure rate (fragility) estimation unit 15 estimates the target facility failure rate (fragility) of an event tree branch event item. The fault tree assessment method is sometimes used to estimate the target facility failure rate (fragility). Next, an event transition assessment unit 16 assesses an event transition and classifies the damage mode after the occurrence of the disaster.

In addition, from the equipment cost information and the alternate equipment cost information, a direct loss amount estimation unit 19 of the data processor 3 estimates an economic loss, for example, a direct loss amount including the equipment loss amount of the building and systems, operating losses, and human costs. At this time, considering the compensation of a casualty insurance, which is an economic compensation, determined by casualty insurance conditions such as the deductible and the maximum amount, the direct loss amount estimation unit 19 estimates the direct loss amount, from which the compensation has been deducted, that is, the direct loss amount that the business owner must bear. A miscellaneous cost estimation unit 20 estimates miscellaneous costs such as the initial cost and the equipment maintenance cost, and a suspension-causing business value loss amount assessment unit 30 assesses the amount of a business value loss caused by the suspension of business. In addition, a casualty insurance premium assessment unit 40, which characterizes this embodiment, assesses the casualty insurance premium considering the conditions such as the deductible and maximum amount of the casualty insurance that has been taken out.

In addition, a loss-cost effect assessment unit 21 of the data processor 3 assesses the loss-cost effect and judges if the resulting direct loss amount, the cost of disaster measures, the suspension-causing business value loss amount, and the casualty insurance premium are within a range assumed by the business owner. If the loss-cost effect assessment is not within the assumed range as the result of this judgment, the system repeats the assessment and, when the condition specified by the business owner or the decision maker is satisfied, terminates the assessment. The data output unit 4 outputs the assessment result as a comprehensive assessment report.

The detail of the following units and methods is the same as that of the first embodiment: disaster (earthquake) hazard curve estimation unit 10, acceleration amplification coefficient (target part response acceleration) estimation unit 12, target facility failure rate (fragility) estimation unit 15, direct loss amount estimation unit 19, event tree creation unit 14, method for calculating the operating loss amount with the casualty insurance compensation taken into consideration, a fault tree used when the target facility failure rate (fragility) estimation unit 15 estimates the target facility failure rate (fragility) of an event tree branch event item, and the method for calculating the equipment loss amount with the casualty insurance compensation taken into consideration. The detail of the method for assessing the suspension-causing business value loss amount at disaster time is also the same as that in the first embodiment. The description of those units and methods is not repeated here because they have already been described.

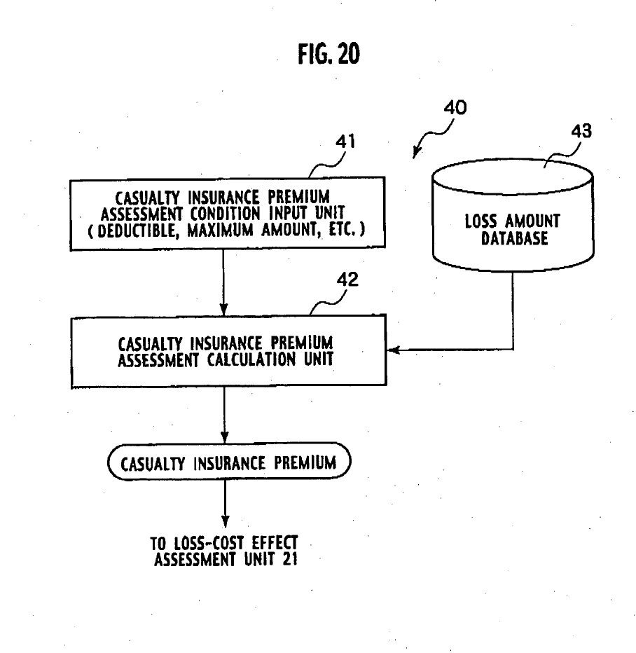

FIG. 20 shows the detail of the processing function of the casualty insurance premium assessment unit 40. The casualty insurance premium assessment unit 40 comprises a casualty insurance premium assessment condition input unit 41, a casualty insurance premium assessment calculation unit 42, and a loss amount database 43. The casualty insurance premium assessment condition input unit 41 receives the deductible, maximum amount, and casualty type for assessing a casualty insurance premium. Based on the input data and on the loss amount data stored in the loss amount database 43, the casualty insurance premium assessment calculation unit 42 performs assessment calculation for the casualty insurance premium, outputs the assessment result of the casualty insurance premium, and sends the result to the loss-cost effect assessment unit 21.

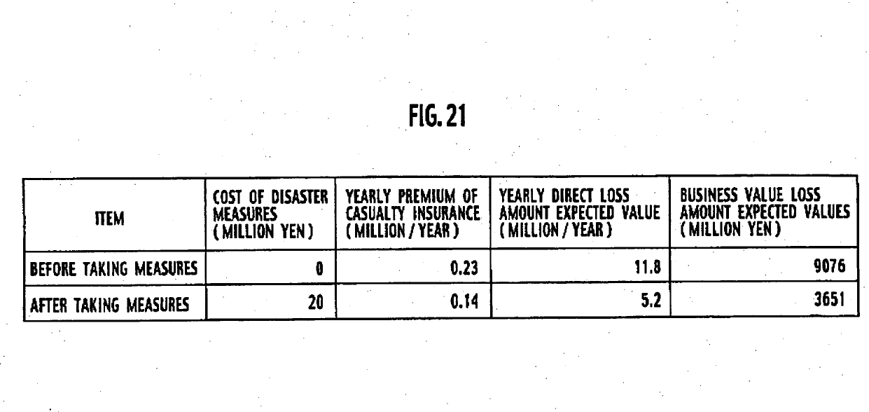

FIG. 21 shows an example of cost versus effect comparison of disaster measures that is obtained from the data output unit 4 of the disaster risk assessment system in this embodiment. In this example, the direct loss amount expected value (expected value of the sum of the equipment loss amount and the operating loss amount) is assessed as a direct loss amount expected value from which the casualty insurance compensation determined by the casualty insurance deductible and maximum amount has been deducted. The compensation is determined according to the casualty insurance condition such as the deductible or the maximum amount. The deductible of the casualty insurance that has been taken out and the casualty insurance premium for the maximum amount are also assessed. FIG. 21 shows a relation, before and after taking measures, among the cost of disaster measures, yearly premium of casualty insurance, yearly direct loss amount expected value, and business value loss amount expected value when a disaster occurs. When taking measures for an assumed disaster event in advance, the business owner and the decision maker can use those relations to understand the cost versus effect in advance.

As described above, the disaster risk assessment system in the fourth embodiment allows a business owner to adequately assess a disaster risk associated with the occurrence of a disaster from an economic point of view. In doing so, this system allows the business owner to assess the direct loss amount, from which the amount compensated by a casualty insurance has been deducted, that is, the direct loss amount that the business owner must bear, with the casualty insurance condition such as the deductible and the maximum amount taken into consideration. The disaster risk assessment system also provides decision-making information on disaster measures that allows the business owner to make an economically feasible, appropriate disaster measures plan and to estimate the cost of the measures.

Next, a disaster risk assessment system in a fifth embodiment of the present invention will be described. The system in this embodiment, a modification of the fourth embodiment of the present invention, is characterized in that a business owner takes out a business casualty insurance but not an equipment casualty insurance.

The functional configuration is similar to that of the fourth embodiment with a difference from the fourth embodiment only in the method for calculating the equipment loss amount. The following describes only the method for calculating the equipment loss amount, without repeating the other functional configuration that has already been described.

The equipment loss amount in the disaster risk assessment system in the fifth embodiment is calculated as follows. The equipment loss amount expected value S is calculated by expression (16),

$$S = {\sum }_{i = 1}^{M} {Q}_{i} {s}_{i} \qquad ( 16 )$$

where sᵢ is the equipment loss amount in the damage mode i, Qᵢ is the damage probability in the damage mode i, and M is the total number of damage modes.

As described above, the disaster risk assessment system in the fifth embodiment allows a business owner to adequately assess a disaster risk associated with the occurrence of a disaster from an economic point of view. In doing so, when the business owner takes out a business casualty insurance but not an equipment casualty insurance, this system allows the business owner to assess the direct loss amount, from which the amount compensated by the business insurance has been deducted, that is, the direct loss amount that the business owner must bear, with the business insurance condition such as the deductible and the maximum amount taken into consideration. The disaster risk assessment system also provides decision-making information on disaster measures that allows the business owner to make an economically feasible, appropriate disaster measures plan and to estimate the cost of the measures.

Next, a disaster risk assessment system in a sixth embodiment of the present invention will be described. The system in this embodiment, a modification of the fourth embodiment of the present invention, is characterized in that a business owner takes out an equipment casualty insurance but not a business casualty insurance.

The functional configuration is similar to that of the fourth embodiment with a difference from the fourth embodiment only in the method for calculating the operating loss amount. The following describes only the method for calculating the operating loss amount, without repeating the other functional configuration that has already been described.

The operating loss amount in the disaster risk assessment system in the sixth embodiment is calculated as follows. The operating loss amount expected value S is calculated by expression (17),

$$S = {\sum }_{i = 1}^{M} {Q}_{i} {s}_{i} \qquad ( 17 )$$

where sᵢ is the operating loss amount in the damage mode i, Qᵢ is the damage probability in the damage mode i, and M is the total number of damage modes.

As described above, the disaster risk assessment system in the sixth embodiment allows a business owner to adequately assess a disaster risk associated with the occurrence of a disaster from an economic point of view. In doing so, when the business owner takes out an equipment casualty insurance but not a business casualty insurance, this system allows the business owner to assess the direct loss amount, from which the amount compensated by the equipment insurance has been deducted, that is, the direct loss amount that the business owner must bear, with the equipment insurance condition such as the deductible and the maximum amount taken into consideration. The disaster risk assessment system also provides decision-making information on disaster measures that allows the business owner to make an economically feasible, appropriate disaster measures plan and to estimate the cost of the measures.

The disaster risk assessment systems in the first to sixth embodiments each are implemented by executing a disaster risk assessment program on a standalone computer or on a plurality of computers connected via a network. The disaster risk assessment program, which causes a computer to execute the disaster risk assessment support function, is stored on a storage medium for distribution as a software product. This program can also be provided via the Internet or other electric communication lines.

Next, a disaster risk assessment system in a seventh embodiment of the present invention will be described. The system in this embodiment is characterized in that a function to receive data on business and management information is added to the data entry unit 2 in the first embodiment of the present invention shown in FIG. 1. Therefore, when the disaster is assumed to be an earthquake, a list of data entered into the data entry unit 2 of the disaster risk assessment system in this embodiment comprises assumed disaster/district information entry data 5, equipment information entry (1) 6, equipment information entry (2) 7, alternate equipment information entry (1) 8, alternate equipment information entry (2) 9, and financial management information entry 91. That is, the financial management information entry 91 is added to the entry data in the first embodiment shown in FIGS. 2A-3C.

The financial management information entry 91 includes income statement data and cash flows statement data that represent the current financial status as well as the estimated values for those statement data for the next and following years, variability estimation data that represents an uncertainty in the data, and calculation parameters, which will be described later, for assessing a business value loss at disaster time. It is necessary for a business establishment, composed of a plurality of business units, to enter financial information as data for each business unit for assessing the disaster risk.

FIG. 15 shows an example of a change in the gross profit obtained from a business that is suspended by a disaster that occurs. When a disaster occurs and there is a loss of the equipment, property, and persons, the business activity is interrupted and the gross profit is either decreased to “usual value×immediately-after-disaster rate” or lost. If there is a stock of merchandises or products, the gross profit may be decreased, based on some time function, after the disaster occurrence time. It is assumed that the business activity or the production operation is stopped before the damaged equipment and property are recovered and that the gross profit remains at the level of the value immediately after the disaster. As the damaged equipment and property are recovered, the operation, business, and production activity are gradually restarted with the gross profit recovered to a given level (gross profit usual value×finally reaching rate). It is assumed that the finally reaching rate of the gross profit is dependent on the recovery time and that, after an assumed renewal period, the rate is decreased according to the market loss curve that is the exponential function of an assumed time constant. For a widespread disaster such as an earthquake, the renewal period depends an assumed recovery period of the public infrastructure, such as electricity and communication lines necessary for the business, and of the securities and commodities exchange. It should be noted that the time constant of the market loss curve is estimated by comparing the recovery period of the owner's company and that of competitors. That is, if the owner's business recovery time is significantly longer than that of competitors, the competitors will win the market, the time constant of the market loss curve becomes smaller, and the finally reaching rate of the gross profit is decreased.

As described above, a temporary suspension of the business activity due to the occurrence of a disaster involves not only a loss during the recovery period but also a risk of permanent loss due to a decrease in the market share. The loss amount at various points in future time is reduced by the capital cost, and the sum of their current values is assessed as the amount of suspension risk caused by the occurrence of a disaster. The current value of the amount, represented by the size of the shaded area (Assessment period×Reduction in gross profit in each period) in FIG. 15, is the business value loss amount caused by the suspension. The parameters required for the calculation include the current profit indexes such as the current yearly gross profit or cash flow, renewal period, recovery period, market or business restart time, and the time constant of the market decay curve. Those parameters are included, partially or in whole, in the data of the financial management information entry 91 shown in FIG. 3C.

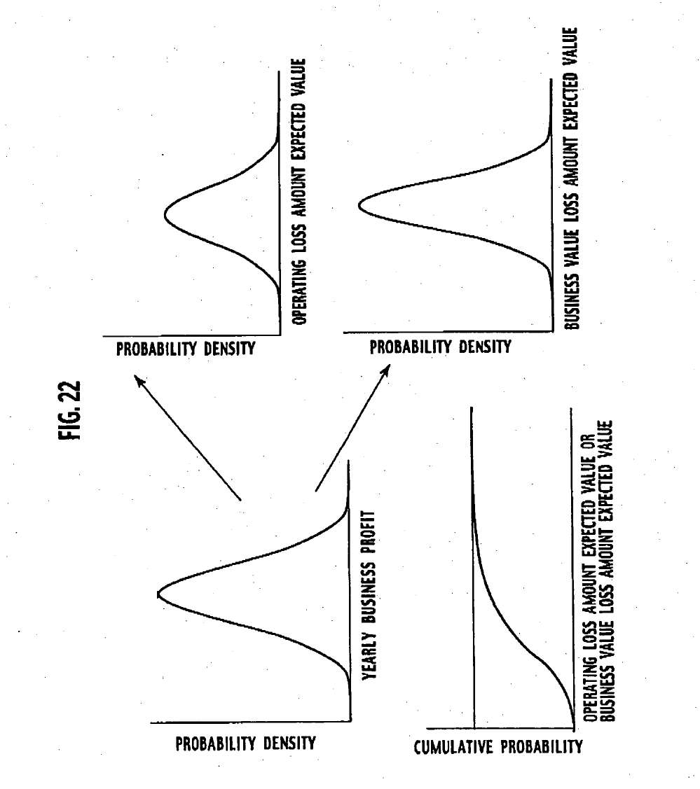

Next, the disaster risk assessment method by the disaster risk assessment system in the embodiment described above will be described. The operating loss amount estimated by the direct loss amount estimation unit 19 in FIG. 4 and the expected amount of the suspension-causing business value loss amount assessed by the business value loss amount assessment unit 30 in FIG. 4 are supposed to be approximately proportional to the business profit per unit period. For example, in the business value loss assessment in FIG. 15, the loss amount is supposed to be proportional to the yearly gross profit. Instead of the gross profit, the cash flow may also be used in the calculation. Those amounts are calculated based on the financial management information entered from the data entry unit 2 in FIG. 1 and on the data entered as financial management information entry 91 in FIG. 3C. However, because the operating loss amount and the business value loss assessment amount are future business profits, the assessment involves an uncertainty that depends on the management environment. Using profit and loss planning data, cash flow planning data, profit and loss/cash flow variability estimation data, which are entered as the financial management information entry 91 in FIG. 3C, the business profit in a period, during which a disaster is assumed to occur, and its fluctuation band are estimated to produce the probability density distribution of the yearly business profit shown in FIG. 22. It is also possible that the standard deviation of the probability density distribution of the yearly business profit is supposed, for example, to be proportional to the square root of the time from the current time to the assessment point. Based on the probability density distribution of the yearly business profit, the probability density distributions of the operating loss amount and the business value loss assessment amount are calculated, and the probability density distributions and the probability distribution shown in FIG. 22 are displayed by the data output unit 4. It is also possible to produce the cumulative probability distribution by integrating the probability density distributions of the operating loss amount and the business value loss assessment amount with the value of the horizontal axis as the variable and to display the resulting distribution on the data output unit 4.

The loss-cost effect assessment unit 21 shown in FIG. 4 assesses the effect of the disaster measures by subtracting the cost of disaster measures from the difference between the disaster-time loss amount before the disaster measures are taken and the disaster-time loss amount after the disaster measures are taken. In this case, again, there is an uncertainty in the operating loss amount and the business value loss assessment amount in connection with an uncertainty in the business profit. Therefore, the loss-cost effect assessment unit 21 calculates the probability density distribution or the cumulative probability distribution of the value generated by subtracting the cost of disaster measures from the operating loss amount and the business value loss assessment amount, and then the data output unit 4 displays the probability density distribution or the cumulative probability distribution such as one shown in FIG. 22. The user of the disaster risk assessment system can perform decision making of the disaster measures by referencing the probability distribution or the probability density distribution of the disaster measures effect. If the cost of disaster measures will occur in future, the cost may be reduced by the capital cost to convert it to the current value for assessment.

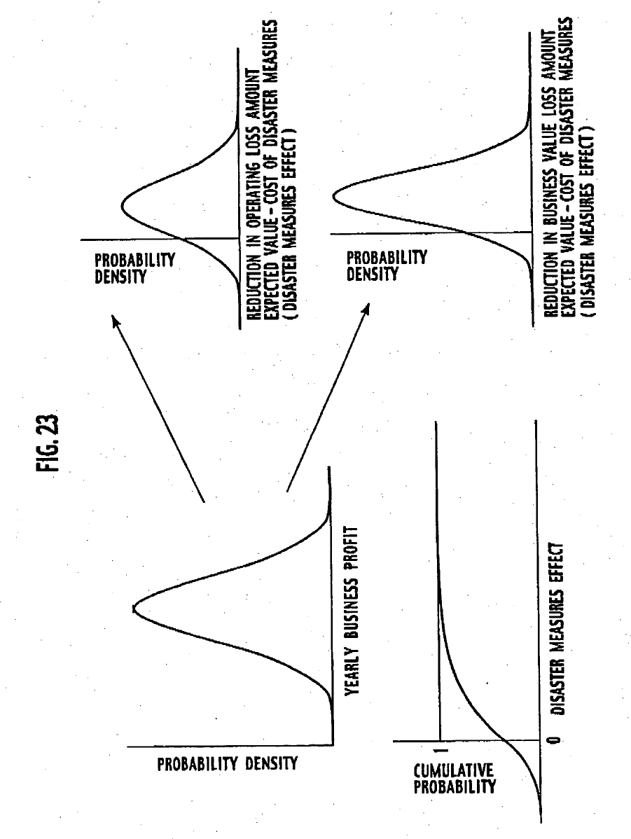

A negative disaster measures effect is also shown in the probability distribution or the probability density distribution of the disaster measures effect in FIG. 23. This means that, even when disaster measures are taken, the reduction in the operating loss amount and the business value loss amount is sometimes lower than the cost of disaster measures. Although it is judged in most cases that no disaster measures will be taken in such a case, preparing or making a disaster measures plan is still worthwhile if the business environment gets better in future and the potential business profit significantly increases. That is, the business owner will take disaster measures not now but when the business profit improves in future. The real-time option method may be used to assess the value of the disaster measures plan. The real-time option value assessment F for the disaster measures can be calculated by expression (18) using the Black-Scholes call option pricing equation, a well-known equation in the financial engineering field, where r is a no-risk interest. The property price S is the difference in the disaster-time loss amount between the current time when no disaster measures are taken and the time when the disaster measures are taken, the exercise price K is the total cost of disaster measures, the volatility σ is the standard deviation of a variation in the business profit or cash flow per unit time, and the expiration T is the period to the time when the disaster measures are taken (number of waiting years).

$$\begin{matrix}F = S Φ ( d ) - {Ke}^{- rt} Φ ( d - σ \sqrt{T} ) \\ d = \frac{ln ( S / K ) + rt}{σ \sqrt{T}} + \frac{σ \sqrt{T}}{2} \\ Φ ( d ) = {\int }_{- ∞}^{α} \frac{1}{\sqrt{2 π}} exp ( - \frac{{z}^{2}}{2} ) ⅆ z\end{matrix} \qquad ( 18 )$$

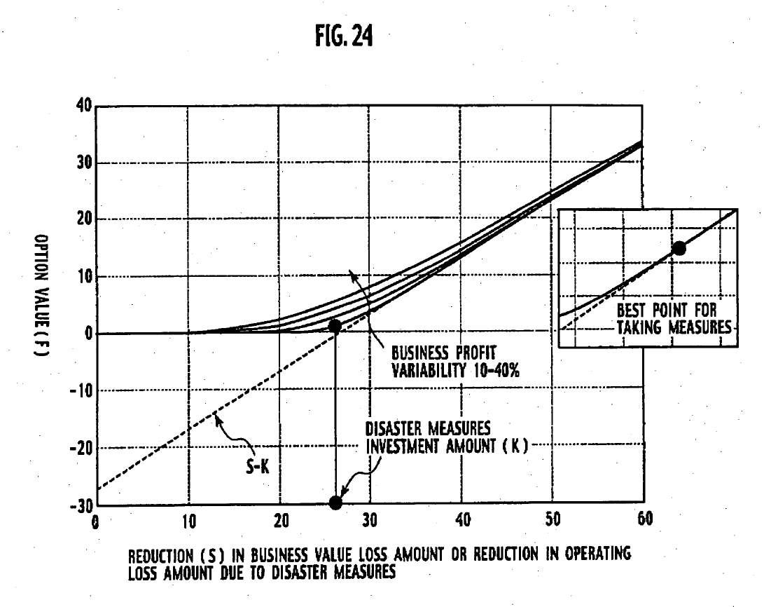

FIG. 24 shows an example of the result obtained by assessing the real option value of disaster measures. The data output unit 4 shown in FIG. 4 outputs the assessment result obtained in this way. The user of the disaster risk assessment system can reference the real option value to decide whether to discard or promote a disaster measures plan. Referring to FIG. 24, it is usually judged that disaster measures should be taken when the disaster measures effect (S=K) is almost equal to the real option value (F) (best point for taking measures), wherein the disaster measures effect is calculated by subtracting the miscellaneous cost required for the disaster measures from the difference in the disaster time loss amount estimated between the current time when no disaster measures are taken and the time when the disaster measures are taken.

For a business establishment for which disaster risk assessment is made and which is composed of a plurality of business units, the effect of disaster occurrence varies according to the business unit when the operating loss amount or business value loss amount at disaster time is assessed. Thus, the function may also be provided such that, for each business unit, the direct loss amount estimation unit 19 in FIG. 4 assesses the operating loss amount, the suspension-causing business value loss amount assessment unit 30 assesses the business value loss amount, the loss-cost effect assessment unit 21 calculates the sum and assesses the effect in the same way, and the data output unit presents the assessment value for each business unit and their total.

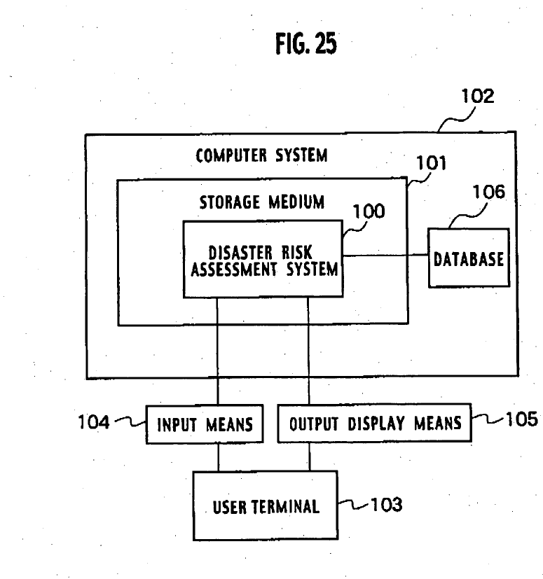

Next, a disaster risk assessment system in an eighth embodiment of the present invention will be described with reference to FIG. 25. The disaster risk assessment system in FIG. 25 is a networked system used by an insurance company or a consulting company, which makes business owner's risk assessment, to perform disaster risk management, assessment, and measures assessment/planning requested by the customer. The configuration of this disaster risk assessment system is that a computer system 102 and a user terminal 103 are connected directly or via a network such as the Internet not shown. The computer system 102 comprises a database 106 required for disaster risk assessment and a storage medium 101 in which a program 100 for executing at least one of disaster risk assessment system functions in the first to seventh embodiments is stored. Based on information presented by the customer, the user can enter data, necessary for requested disaster risk assessment and disaster measures assessment, from input means 104 and can output and display the calculated result through display means 105.

The system in this embodiment allows an insurance company or a consulting company, which makes business owner's risk assessment, to conduct a business for supporting disaster risk assessment or disaster measures assessment. Note that the user may be a customer of a company that has obtained a usage license from a company that owns the system.

As described above, when a direct loss amount such as a facility loss amount and an operating loss amount is assessed during disaster risk assessment, the system according to the present invention allows a business owner to assess the direct loss amount, from which the amount compensated by a casualty insurance has been deducted, that is, the direct loss amount that the business owner must bear, with the casualty insurance condition such as the deductible and the maximum amount taken into consideration. Therefore, in assessing the total cost including a business value loss amount caused by a suspension due to a disaster, the business owner can make an economically feasible, appropriate disaster measures plan and estimate the cost of the measures.

In addition, in assessing a disaster risk, the system according to the present invention allows a business owner to assess an operating loss amount and a business value loss amount that may be caused by a potential disaster and to assess the real option value of a disaster measures plan with an uncertainty in the future business profit and cash flow in mind, thus providing a disaster risk assessment system that can assess a disaster risk more adequately and support the decision making of disaster measures execution.

It should be understood that many modifications and adaptations of the invention will become apparent to those skilled in the art and it is intended to encompass such obvious modifications and changes in the scope of the claims appended hereto.

What is claimed is:

1. A disaster risk assessment system comprising a function that compares a function-losing event occurrence frequency and a direct loss amount such as a facility loss amount in current equipment with a function-losing event occurrence frequency and a direct loss amount such as a facility loss amount after taking equipment measures for presenting decision-making information on equipment measures, based on input data on an event tree branch item sequence, an initial event occurrence frequency, information on a response to a target facility when an event occurs in current equipment and multiple pieces of counter-disaster equipment of an event tree target facility, an event occurrence time damage probability, a mission time, a conditional failure probability, and a cost of current equipment and counter-disaster equipment of an event target facility.

2. The disaster risk assessment system according to claim 1, further comprising a function that assesses a difference between a sum of the direct loss amount and a business value loss amount at disaster time in the current equipment and a sum of the direct loss amount and a business value loss amount at disaster time in the counter-disaster equipment after taking disaster measures and compares the difference with a disaster measures equipment cost for presenting decision making information on disaster measures.

3. The disaster risk assessment system according to claim 1, further comprising a function that compares a sum of a casualty insurance premium against a disaster and a disaster measures equipment cost in the current equipment with a sum of a casualty insurance premium against a disaster and a disaster measures equipment cost in the counter-disaster equipment after disaster measures are taken for presenting decision making information on disaster measures.

4. The disaster risk assessment system according to claim 1, further comprising a function that compares a total cost, which is generated by subtracting an insurance amount at disaster time from a sum of the direct loss amount at disaster time, disaster measures equipment cost, disaster measures management cost, suspension-causing a business value loss amount at disaster time, and casualty insurance premium against a disaster in the current equipment, with a total cost, which is generated by subtracting an insurance amount at disaster time from a sum of the direct loss amount at disaster time, disaster measures equipment cost, disaster measures management cost, suspension-causing a business value loss amount at disaster time, and casualty insurance premium against a disaster in the counter-disaster equipment after disaster measures are taken, for presenting decision making information on disaster measures.

5. The disaster risk assessment system according to claim 2 wherein said business value loss amount is a business value loss amount assessed considering a time-based decrease in a market share due to a suspension and a restart from the suspension.

6. The disaster risk assessment system according to claim 5 wherein said business value loss amount is assessed from a difference between a current value of a total future profit or a total cash flow obtained from the business when a suspension occurs and a current value of a total future profit or a total cash flow expected when no suspension occurs.

7. The disaster risk assessment system according to claim 5, further comprising a function that assesses a business value loss amount expected value of a disaster based on occurrence probabilities of a plurality of loss events assessed by an event tree of loss events created for the disaster and on a suspension-causing business value loss amount generated corresponding to said event tree and said plurality of loss events.

8. The disaster risk assessment system according to claim 7 wherein said plurality of loss events are rearranged in descending order of occurrence probabilities thereof and said business value loss amount expected value of a disaster is assessed according to an expression given below using the suspension-causing business value loss amount generated corresponding to said plurality of loss events,
$$V = {\sum }_{k = 0}^{n} {p}_{k} Δ {v}_{k}$$
where,
V: Expected value of suspension-causing business value loss amount
n: No. of assumed loss events
pₖ: Occurrence probability of k-th loss event (pₖ≦Pₖ₋₁, K=1, 2, . . . , n)
Δv₀=v₀
Δvₖ=vₖ−vₖ₋₁ (vₖ≧vₖ₋₁, k=1, 2, . . . , n)
Δvₖ=0 (vₖ<vₖ₋₁, k=1, 2, . . . , n)
vₖ: Business value loss amount for k-th loss event

9. A disaster risk assessment system comprising:
a data entry unit that receives data on an assumed disaster event, a relation between an assumed disaster occurrence frequency and a disaster scale, event tree information, equipment data on a target facility that is an event tree branch item, response analysis information on equipment of a target facility for a disaster event, degree-of-damage information on equipment of a target facility, an equipment reconstruction cost of a target facility, a number of days for recovery, an operating loss amount, deductible or maximum amount or premium data on casualty insurance of a target facility, alternate equipment data on a target facility that is an event tree branch item, response analysis information on alternate equipment of a target facility for a disaster event, degree-of-damage information on alternate equipment of a target facility, an alternate equipment reconstruction cost of a target facility, a number of days for recovery, an operating loss amount, and a deductible or maximum amount or premium of casualty insurance of a target facility when alternate equipment is installed;
a hazard curve estimation unit that gives a disaster hazard curve of a target district;
an occurrence frequency assessment unit that assesses an occurrence frequency of a disaster event based on said disaster hazard curve;
a target part response assessment unit that assesses a response acceleration of a target part using an acceleration amplification coefficient for each target part of a target building;
a target facility failure rate estimation unit that calculates a target facility failure rate of an event tree branch event item based on an assessment result of said target part response assessment unit;
a disaster loss amount assessment unit that assesses a damage probability, a direct loss amount, and a suspension-causing business value loss amount of a corresponding damage mode by classifying a damage mode after the occurrence of a disaster based on event tree information;
a direct loss amount expected value calculation unit that calculates a direct loss amount expected value by calculating a total of products of the damage probability and the direct loss amount of the damage modes;
a business value loss amount expected value estimation unit that calculates a business value loss amount expected value by calculating a total of products of the damage probability and the business value loss amount of the damage modes; and
an information presentation unit that presents decision making information on disaster measures by comparing a function-losing event occurrence frequency, a direct loss amount expected value, a disaster measures cost, a business value loss amount expected value, and a casualty insurance premium in current equipment with a function-losing event occurrence frequency, a direct loss amount expected value, a disaster measures cost, a business value loss amount expected value, and a casualty insurance premium in counter-disaster equipment after disaster measures are taken,
wherein said disaster loss amount assessment unit uses a direct loss amount, from which a casualty insurance compensation determined by a casualty insurance deductible and maximum amount is deducted, as the direct loss amount, and
wherein said direct loss amount expected value calculation unit uses a direct loss amount expected value, from which a casualty insurance compensation determined by a casualty insurance deductible and maximum amount is deducted, as the direct loss amount expected value.

10. The disaster risk assessment system according to claim 9 wherein said direct loss amount includes an operating loss amount, wherein said operating loss amount is an operating loss amount from which a business casualty insurance compensation determined by a business casualty insurance deductible and maximum amount is deducted, and wherein an operating loss amount expected value is an operating loss amount expected value from which the business casualty insurance compensation determined by the business casualty insurance deductible and maximum amount is deducted.

11. The disaster risk assessment system according to claim 9 wherein said direct loss amount includes an equipment loss amount, wherein said equipment loss amount is an equipment loss amount from which an equipment casualty insurance compensation determined by an equipment casualty insurance deductible and maximum amount is deducted, and wherein an equipment loss amount expected value is an equipment loss amount expected value from which the equipment casualty insurance compensation determined by the equipment casualty insurance deductible and maximum amount is deducted.

12. The disaster risk assessment system according to claim 9 wherein said casualty insurance premium determined by said casualty insurance deductible and maximum amount is assessed.

13. The disaster risk assessment system according to claim 9 wherein said business value loss amount is a business value loss amount including a profit and loss of a time-based decrease in a market share due to a suspension and a restart of business.

14. The disaster risk assessment system according to claim 13 wherein said business value loss amount is assessed from a difference between a current value of a total future profit or a total cash flow obtained from the business when a suspension occurs and a current value of a total future profit or a total cash flow expected when no suspension occurs.

15. The disaster risk assessment system according to claim 13, wherein a business value loss amount expected value of a disaster is assessed based on occurrence probabilities of a plurality of loss events obtained from event tree information on loss events created for the disaster and on a suspension-causing business value loss amount generated corresponding to said event tree information and said plurality of loss events.

16. The disaster risk assessment system according to claim 15 wherein said plurality of loss events are rearranged in descending order of occurrence probabilities, wherein a difference between the business value loss amount of a particular loss event and the business value loss amount of a loss event in a level immediately preceding the particular loss event is compared with 0, and wherein a total sum of amounts, each generated by multiplying the difference greater than 0 by the occurrence probability of the particular loss event, and an amount generated by multiplying the business value loss amount of a highest-occurrence-probability loss event by the occurrence probability thereof is established as the business value loss amount expected value of the disaster.

17. A disaster risk assessment support method causing a computer to assess a difference between a sum of a direct loss amount and a business value loss amount at disaster time in current equipment and a sum of a direct loss amount and a business value loss amount at disaster time in counter-disaster equipment after taking disaster measures and to compare the difference with a disaster measures equipment cost for presenting decision making information on disaster measures.

18. The disaster risk assessment support method according to claim 17, said method further causing the computer to compare a sum of a casualty insurance premium against a disaster and a disaster measures equipment cost in the current equipment with a sum of a casualty insurance premium against a disaster and a disaster measures equipment cost in the counter-disaster equipment for presenting decision making information on disaster measures.

19. The disaster risk assessment support method according to claim 17, said method further causing the computer to compare a total cost, which is generated by subtracting an insurance amount at disaster time from a sum of the direct loss amount at disaster time, disaster measures equipment cost, disaster measures management cost, suspension-causing business value loss amount at disaster time, and a casualty insurance premium against a disaster in the current equipment, with a total cost, which is generated by subtracting an insurance amount at disaster time from a sum of the direct loss amount at disaster time, disaster measures equipment cost, disaster measures management cost, suspension-causing business value loss amount at disaster time, and a casualty insurance premium against a disaster in the counter-disaster equipment after disaster measures are taken, for presenting decision making information on disaster measures.

20. A disaster risk assessment support method causing a computer to perform the steps of:
receiving data on an assumed disaster event, a relation between an assumed disaster occurrence frequency and a disaster scale, event tree information, equipment data on a target facility that is an event tree branch item, response analysis information on equipment of a target facility for a disaster event, degree-of-damage information on equipment of a target facility, an equipment reconstruction cost of a target facility, a number of days for recovery, an operating loss amount, deductible or maximum amount or premium data on casualty insurance of a target facility, alternate equipment data on a target facility that is an event tree branch item, response analysis information on alternate equipment of a target facility for a disaster event, degree-of-damage information on alternate equipment of a target facility, an alternate equipment reconstruction cost of a target facility, a number of days for recovery, an operating loss amount, and a deductible or maximum amount or premium of casualty insurance of a target facility when alternate equipment is installed;
giving a disaster hazard curve of a target district;
assessing an occurrence frequency of a disaster event based on said disaster hazard curve;
assessing a response acceleration of a target part using an acceleration amplification coefficient for each target part of a target building;
calculating a target facility failure rate of an event tree branch event item based on an assessment result of said step of assessing a response acceleration of a target part;
assessing a damage probability, a direct loss amount, and a suspension-causing business value loss amount of a corresponding damage mode by classifying a damage mode after the occurrence of a disaster based on event tree information;
calculating a direct loss amount expected value by calculating a total of products of the damage probability and the direct loss amount of the damage modes;
calculating a business value loss amount expected value by calculating a total of products of the damage probability and the business value loss amount of the damage modes; and
presenting decision making information on disaster measures by comparing a function-losing event occurrence frequency, a direct loss amount expected value, a disaster measures cost, a business value loss amount expected value, and a casualty insurance premium in current equipment with a function-losing event occurrence frequency, a direct loss amount expected value, a disaster measures cost, a business value loss amount expected value, and a casualty insurance premium in counter-disaster equipment after disaster measures are taken,
wherein said step of assessing a disaster loss amount uses a direct loss amount, from which a casualty insurance compensation determined by a casualty insurance deductible and maximum amount is deducted, as the direct loss amount, and
wherein said step of calculating a direct loss amount expected value uses a direct loss amount expected value, from which a casualty insurance compensation determined by a casualty insurance deductible and maximum amount is deducted, as the direct loss amount expected value.

21. The disaster risk assessment support method according to claim 20 wherein said direct loss amount includes an operating loss amount, wherein said operating loss amount is an operating loss amount from which a business casualty insurance compensation determined by a business casualty insurance deductible and maximum amount is deducted, and wherein an operating loss amount expected value is an operating loss amount expected value from which the business casualty insurance compensation determined by the business casualty insurance deductible and maximum amount is deducted.

22. The disaster risk assessment support method according to claim 20 wherein said direct loss amount includes an equipment loss amount, wherein said equipment loss amount is an equipment loss amount from which an equipment casualty insurance compensation determined by an equipment casualty insurance deductible and maximum amount is deducted, and wherein an equipment loss amount expected value is an equipment loss amount expected value from which the equipment casualty insurance compensation determined by the equipment casualty insurance deductible and maximum amount is deducted.

23. The disaster risk assessment support method according to claim 20, said method causing the computer to assess said casualty insurance premium determined by said casualty insurance deductible and maximum amount.

24. The disaster risk assessment support method according to claim 20 wherein said business value loss amount is a business value loss amount including a profit and loss of a time-based decrease in a market share due to a suspension and a restart of business.

25. The disaster risk assessment support method according to claim 24, said method causing the computer to assess said business value loss amount from a difference between a current value of a total future profit or a total cash flow obtained from the business when a suspension occurs and a current value of a total future profit or a total cash flow expected when no suspension occurs.

26. The disaster risk assessment support method according to claim 24, said method causing the computer to assess a business value loss amount expected value of a disaster based on occurrence probabilities of a plurality of loss events obtained from event tree information on loss events created for the disaster and on a suspension-causing business value loss amount generated corresponding to said event tree information and said plurality of loss events.

27. The disaster risk assessment support method according to claim 26, said method causing the computer to rearrange said plurality of loss events in descending order of occurrence probabilities; to compare a difference between the business value loss amount of a particular loss event and the business value loss amount of a loss event in a level immediately preceding the particular loss event with 0; and to establish a total sum of amounts, each generated by multiplying the difference greater than 0 by the occurrence probability of the particular loss event, and an amount, generated by multiplying the business value loss amount of a highest-occurrence-probability loss event by the occurrence probability thereof, as the business value loss amount expected value of the disaster.

28. A disaster risk assessment system comprising:
a data entry unit that receives data on an assumed disaster event, a relation between an assumed disaster occurrence frequency and a disaster scale, event tree information, equipment data on a target facility that is an event tree branch item, response analysis information on equipment of a target facility for a disaster event, degree-of-damage information on equipment of a target facility, an equipment reconstruction cost of a target facility, a number of days for recovery, an operating loss amount, deductible or maximum amount or premium data on casualty insurance of a target facility, alternate equipment data on a target facility that is an event tree branch item, response analysis information on alternate equipment of a target facility for a disaster event, degree-of-damage information on alternate equipment of a target facility, an alternate equipment reconstruction cost of a target facility, a number of days for recovery, an operating loss amount, and a deductible or maximum amount or premium of casualty insurance of a target facility when alternate equipment is installed;
a hazard curve estimation unit that gives a disaster hazard curve of a target district;
an occurrence frequency assessment unit that assesses an occurrence frequency of a disaster event based on said disaster hazard curve;
a target part response assessment unit that assesses a response acceleration of a target part using an acceleration amplification coefficient for each target part of a target building;
a target facility failure rate estimation unit that calculates a target facility failure rate of an event tree branch event item based on an assessment result of said target part response assessment unit;
a disaster loss amount assessment unit that assesses a damage probability, a direct loss amount, and a suspension-causing business value loss amount of a corresponding damage mode by classifying a damage mode after the occurrence of a disaster based on event tree information;
a direct loss amount expected value calculation unit that calculates a direct loss amount expected value by calculating a total of products of the damage probability and the direct loss amount of the damage modes;
a business value loss amount expected value estimation unit that calculates a business value loss amount expected value by calculating a total of products of the damage probability and the business value loss amount of the damage modes; and
an information presentation unit that presents decision making information on disaster measures by comparing a function-losing event occurrence frequency, a direct loss amount expected value, a disaster measures cost, a business value loss amount expected value, and a casualty insurance premium in current equipment with a function-losing event occurrence frequency, a direct loss amount expected value, a disaster measures cost, a business value loss amount expected value, and a casualty insurance premium in counter-disaster equipment after disaster measures are taken,
wherein said business value loss amount expected value estimation unit calculates said business value loss amount expected value based on a probability distribution of a business profit or a cash flow.

29. The disaster risk assessment system according to claim 28 wherein said business value loss amount expected value estimation unit assesses a disaster measures effect based on the probability distribution of a business profit or a cash flow and causes said information presentation unit to present the disaster measures effect, wherein the disaster measures effect is a value generated by subtracting a sum of a business value loss amount expected value assessed assuming that disaster measures will be taken and a total cost for taking disaster measures from a business value loss amount expected value assessed in a current business environment in which no disaster measures is taken.

30. The disaster risk assessment system according to claim 28 wherein said business value loss amount expected value estimation unit assesses a real option value and causes said information presentation unit to present the real option value, wherein a property value is a value generated by subtracting a business value loss amount expected value assessed assuming that disaster measures will be taken from a business value loss amount expected value assessed in a current business environment in which no disaster measures is taken, a volatility is a standard deviation of a variation in a business profit or a cash flow per unit time, an exercise price is a total cost for taking disaster measures, and an expiration is a period to a time when disaster measures are taken.

31. The disaster risk assessment system according to claim 28, further comprising a function that assesses the operating loss amount and the business value loss amount of each business unit within a business establishment for which disaster risk assessment is made and presents the assessment value of each business unit and a total of all business units.

32. A disaster risk assessment system comprising:
a data entry unit that receives data on an assumed disaster event, a relation between an assumed disaster occurrence frequency and a disaster scale, event tree information, equipment data on a target facility that is an event tree branch item, response analysis information on equipment of a target facility for a disaster event, degree-of-damage information on equipment of a target facility, an equipment reconstruction cost of a target facility, a number of days for recovery, an operating loss amount, deductible or maximum amount or premium data on casualty insurance of a target facility, alternate equipment data on a target facility that is an event tree branch item, response analysis information on alternate equipment of a target facility for a disaster event, degree-of-damage information on alternate equipment of a target facility, an alternate equipment reconstruction cost of a target facility, a number of days for recovery, an operating loss amount, and a deductible or maximum amount or premium of casualty insurance of a target facility when alternate equipment is installed;
a hazard curve estimation unit that gives a disaster hazard curve of a target district;
an occurrence frequency assessment unit that assesses an occurrence frequency of a disaster event based on said disaster hazard curve;
a target part response assessment unit that assesses a response acceleration of a target part using an acceleration amplification coefficient for each target part of a target building;
a target facility failure rate estimation unit that calculates a target facility failure rate of an event tree branch event item based on an assessment result of said target part response assessment unit;
a disaster loss amount assessment unit that assesses a damage probability, a direct loss amount, and a suspension-causing business value loss amount of a corresponding damage mode by classifying a damage mode after the occurrence of a disaster based on event tree information;
a direct loss amount expected value calculation unit that calculates a direct loss amount expected value by calculating a total of products of the damage probability and the direct loss amount of the damage modes;
a business value loss amount expected value estimation unit that calculates a business value loss amount expected value by calculating a total of products of the damage probability and the business value loss amount of the damage modes; and
an information presentation unit that presents decision making information on disaster measures by comparing a function-losing event occurrence frequency, a direct loss amount expected value, a disaster measures cost, a business value loss amount expected value, and a casualty insurance premium in current equipment with a function-losing event occurrence frequency, a direct loss amount expected value, a disaster measures cost, a business value loss amount expected value, and a casualty insurance premium in counter-disaster equipment after disaster measures are taken,
wherein said business value loss amount expected value estimation unit assesses said operating loss amount expected value based on a probability distribution of a business profit or a cash flow.

33. The disaster risk assessment system according to claim 32 wherein a disaster measures effect is assessed and presented based on the probability distribution of a future business profit or a cash flow, wherein the disaster measure effect is a value generated by subtracting a sum of an operating loss amount expected value assessed assuming that disaster measures will be taken and a total cost for taking disaster measures from an operating loss amount expected value assessed in a current business environment in which no disaster measures is taken.

34. The disaster risk assessment system according to claim 32 wherein a real option value is assessed, wherein a property value is a value generated by subtracting an operating loss amount expected value assessed assuming that disaster measures will be taken from an operating loss amount expected value assessed in a current business environment in which no disaster measures is taken, a volatility is a standard deviation of a variation in a business profit or a cash flow per unit time, an exercise price is a total cost for taking disaster measures, and an expiration is a period to a time when disaster measures are taken.

35. The disaster risk assessment system according to claim 32, further comprising a function that assesses the operating loss amount and the business value loss amount of each business unit within a business establishment for which disaster risk assessment is made and presents the assessment value of each business unit and a total of all business units.

36. A disaster risk assessment service providing system comprising:
input means for receiving a user-desired calculation condition, sent from a user terminal via a network, for input to said system;
the disaster risk assessment system according to claim 28 that calculates at least one disaster risk assessment value based on the user-desired calculation condition received by said input means; and
output means for sending a disaster risk assessment value, calculated by said disaster risk assessment system, to said user terminal.

37. A disaster risk assessment service providing system comprising:
input means for receiving a user-desired calculation condition, sent from a user terminal via a network, for input to said system;
the disaster risk assessment system according to claim 32 that calculates at least one disaster risk assessment value based on the user-desired calculation condition received by said input means; and
output means for sending a disaster risk assessment value, calculated by said disaster risk assessment system, to said user terminal.

38. A disaster risk assessment method comprising the steps of:
receiving data on an assumed disaster event, a relation between an assumed disaster occurrence frequency and a disaster scale, event tree information, equipment data on a target facility that is an event tree branch item, response analysis information on equipment of a target facility for a disaster event, degree-of-damage information on equipment of a target facility, an equipment reconstruction cost of a target facility, a number of days for recovery, an operating loss amount, deductible or maximum amount or premium data on casualty insurance of a target facility, alternate equipment data on a target facility that is an event tree branch item, response analysis information on alternate equipment of a target facility for a disaster event, degree-of-damage information on alternate equipment of a target facility, an alternate equipment reconstruction cost of a target facility, a number of days for recovery, an operating loss amount, and a deductible or maximum amount or premium of casualty insurance of a target facility when alternate equipment is installed;
obtaining a disaster hazard curve of a target district;
assessing an occurrence frequency of a disaster event based on said disaster hazard curve;
assessing a response acceleration of a target part using an acceleration amplification coefficient for each target part of a target building;
calculating a target facility failure rate of an event tree branch event item based on an assessment result of said step of assessing a response acceleration of a target part;
assessing a damage probability, a direct loss amount, and a suspension-causing business value loss amount of a corresponding damage mode by classifying a damage mode after the occurrence of a disaster based on event tree information;
calculating a direct loss amount expected value by calculating a total of products of the damage probability and the direct loss amount of the damage modes;
calculating a business value loss amount expected value by calculating a total of products of the damage probability and the business value loss amount of the damage modes; and
presenting decision making information on disaster measures by comparing a function-losing event occurrence frequency, a direct loss amount expected value, a disaster measures cost, a business value loss amount expected value, and a casualty insurance premium in current equipment with a function-losing event occurrence frequency, a direct loss amount expected value, a disaster measures cost, a business value loss amount expected value, and a casualty insurance premium in counter-disaster equipment after disaster measures are taken,
wherein a disaster measures effect is assessed based on the probability distribution of a business profit or a cash flow, wherein the disaster measure effect is a value generated by subtracting a sum of a business value loss amount or an operating loss amount expected value assessed assuming that disaster measures will be taken and a total cost for taking disaster measures from a business value loss amount or an operating loss amount expected value assessed in a current business environment in which no disaster measures is taken.

39. A disaster risk assessment service providing method comprising the steps of:
receiving a user-desired calculation condition, sent from a user terminal via a network, for input;
calculating at least one disaster risk assessment value, using the disaster risk assessment system according to claim 28, based on the user-desired calculation condition that is received; and
sending the calculated disaster risk assessment value to said user terminal.
